(19) United States
(12) Patent Application Publication
(10) Pub. No.: US 2023/0037318 A1
(43) Pub. Date: Feb. 9, 2023

(54) SYSTEMS AND METHODS FOR OPERATING AN AUTONOMOUS VEHICLE

(71) Applicant: TUSIMPLE, INC., San Diego, CA (US)

(72) Inventors: Scott Douglas FOSTER, San Diego, CA (US); Neil M. OVERMON, Redwood City, CA (US); Erik Orlando PORTILLO, Sterling, VA (US); Zhujia SHI, San Diego, CA (US); Joyce TAM, Pleasanton, CA (US); Sridhar Kumar, Fremont, CA (US)

(21) Appl. No.: 17/814,794

(22) Filed: Jul. 25, 2022

Related U.S. Application Data
(60) Provisional application No. 63/225,529, filed on Jul. 25, 2021.
(60) Provisional application No. 63/225,506, filed on Jul. 25, 2021.

(51) Int. Cl. G05D 1/00; G07C 5/00; G07C 5/08

(52) U.S. Cl. CPC G05D 1/0022; G05D 1/0077; G05D 1/0027; G07C 5/008; G07C 5/0808; G05D 2201/0213

(57) ABSTRACT

An autonomous vehicle (AV) includes features that allows the AV to comply with applicable regulations and statues for performing safe driving operation. An example system for an AV includes a communications gateway device. The communications gateway device includes a plurality of modules each configured for different communication mediums or applications. In particular, the plurality of modules includes a first module for communicating with a remote computer. Via the first module, vehicle operational data is reported to the remote computer, and instructional data is received from the remote computer. The modules further include a second module for communicating with devices located within a vicinity external to the vehicle, and a third module configured to communicate with subsystems located within the vehicle. The example AV system includes a second communications gateway device that is configured to be redundant.

### PRIORITY CLAIMS AND RELATED PATENT APPLICATIONS

This patent document claims the priority to and the benefits of U.S. Provisional Application No. 63/225,529 entitled “SYSTEM AND METHOD FOR AN AUTONOMOUS VEHICLE” filed on Jul. 25, 2021, and U.S. Provisional Application No. 63/225,506 entitled “SYSTEM AND METHOD FOR AN AUTONOMOUS VEHICLE” filed on Jul. 25, 2021. The entire disclosures of the aforementioned applications are hereby incorporated by reference as part of the disclosure of this application.

### TECHNICAL FIELD

The present disclosure relates generally to autonomous vehicles. More particularly, the present disclosure is related to operating an autonomous vehicle (AV) appropriately on public roads, highways, and locations with other vehicles or pedestrians.

### BACKGROUND

Autonomous vehicle technologies can provide vehicles that can safely navigate towards a destination with limited or no driver assistance. The safe navigation of an autonomous vehicle from one point to another may include the ability to signal other vehicles, navigating around other vehicles in shoulders or emergency lanes, changing lanes, biasing appropriately in a lane, and navigate all portions or types of highway lanes. Autonomous vehicle technologies may enable an AV to operate without requiring extensive learning or training by surrounding drivers, by ensuring that the AV can operate safely, in a way that is evident, logical, or familiar to surrounding drivers and pedestrians.

### SUMMARY

Systems and methods are described herein that can allow an autonomous vehicle to navigate from a first point to a second point. In some embodiments, the AV can navigate from the first point to the second point without a human driver present in the AV and to comply with instructions for safe and lawful operation. In particular, autonomous navigation of the AV involves communication between the AV and an oversight system, a cloud system, a remote computer, and/or the like. Example embodiments disclose communications gateway devices and configurations thereof to enable communication between an AV and an oversight system.

In one exemplary aspect, an autonomous driving system is disclosed. The autonomous driving system includes a computer located in a vehicle, and the computer is configured to determine instructions for autonomous operation of the vehicle. For example, the computer determines instructions and transmits the instructions to various subsystems of the vehicle (e.g., a drive subsystem, a power subsystem, a steering subsystem) to cause operation of the vehicle.

The autonomous driving system further includes a communications gateway device communicatively coupled with the computer located in the vehicle. The communications gateway device is configured to communicate with a remote computer located at a remote location outside of the vehicle (e.g., an oversight system). For example, the communications gateway device includes a first module configured to wirelessly communicate data (first data) between the computer located in the vehicle and the remote computer. In some examples, the first module includes a cellular communication sub-module and/or a satellite modem.

The communications gateway device further includes a second module and a third module. The second module is configured to communicate data between the computer located in the vehicle and one or more devices located within a vicinity external to the vehicle, or one or more local devices located within a local area of the vehicle. For example, the second module includes a near-field communication (NFC) sub-module, and the second module is configured to detect a presence of a physical key device near the vehicle.

The third module is configured to communicate data between the computer located in the vehicle and one or more subsystems located in or on the vehicle. For example, the third module includes at least one of one or more Ethernet interfaces or a controller area network (CAN) interface. The subsystems include a sensor subsystem, and the third module is configured to receive sensor data (third data) collected by the sensor subsystem. In some embodiments, the computer is configured to control autonomous operation of the vehicle based on receiving the first data and the third data from the first module and the third module, respectively.

In some embodiments, the communications gateway device includes a processor configured to perform operations including obtaining operational data that describes an operation of the vehicle. For example, the operational data includes sensor data collected by a sensor subsystem of the vehicle. The operations further include providing the operational data to the remote computer via the first module or to the one or more devices via the second module. The operations further include receiving, via the first module, instructional data from the remote computer. The instructional data is configured to cause operation of the vehicle.

In some embodiments, the processor is configured to perform operations further including receiving, via the first module, a satellite signal including a timing signal; providing, via the third module, timing information to the subsystems located within the vehicle, wherein the timing information is based on the timing signal; and receiving, via the third module, sensor data collected by the subsystems in accordance with the timing information. In some embodiments, the processor is configured to perform operations including defining a plurality of software security environments each corresponding to one of the first module or the second module. In some embodiments, the processor is configured to perform operations including responsive to receiving second data that includes NFC data indicating a presence of a physical key device, enabling access to an interior portion of the vehicle. In some embodiments, the processor is configured to perform operations further including determining that a first data is not able to be communicated with the remote computer via the first module; and transmitting an indication to a vehicle control computer to cause the vehicle to reach a complete stop based on the first data being not able to be communicated with the remote computer.

In another exemplary aspect, a communications gateway device of a vehicle is disclosed. The communications gateway device includes a first module, a second module, and a third module. The first module is configured to wirelessly communicate data between a computer located in the vehicle and a remote computer. The second module is configured to communicate data between the computer and local devices (e.g., a physical key device, a maintenance system, a cargo loading system, a warehouse system, a toll system, etc.) located within a local area of the vehicle. The third module is configured to communicate data between the computer and one or more subsystems located in or on the vehicle. For example, the subsystems include a sensor subsystem, a drive subsystem, a power subsystem, and/or the like.

In yet another exemplary aspect, an autonomous vehicle is disclosed. The autonomous vehicle includes a computer configured to transmit instructions to subsystems of the autonomous vehicle to cause operation of the autonomous vehicle. The autonomous vehicle further includes two or more communications gateway devices communicatively coupled to the computer. Each communications gateway device is configured to communicate with a remote computer located at a location outside of the autonomous vehicle. The two or more communications gateway devices provide redundancy, and each device is associated with a gateway priority that controls an order by which corresponding data is stored, processed, transmitted, and/or the like.

In yet another exemplary aspect, a remote computer is described. A remote computer configured to remotely communicate with a plurality of vehicles. The remote computer includes a processor configured to perform operations including determining an instructional data for a vehicle of the plurality of vehicles. The instructional data is based on data previously received from one or more of the plurality of vehicles. The operations further include identifying one or more communications gateway devices associated with the vehicle. The operations further include transmitting the instructional data to each of the one or more communications gateway devices associated with the vehicle.

In yet another exemplary aspect, a method for remote communication between a plurality of vehicles and a remote computer is disclosed. The method includes determining an instructional data for a vehicle of the plurality of vehicles based on data previously received from one or more of the plurality of vehicles; identifying one or more communications gateway devices associated with the vehicle; and transmitting the instructional data to each of the one or more communications gateway devices associated with the vehicle.

In some embodiments, the instructional data is configured to (i) be provided by the one or more communications gateway devices to a control computer located on the vehicle, and (ii) cause an operation of the vehicle. In some embodiments, the data that is previously received is received from one or more communications gateway devices for each of the one or more vehicles, and the data comprises sensor data collected from a sensor subsystem of each of the one or more vehicles. In some embodiments, the method further includes, in response to the instructional data including a streaming request, receiving audio data or image data from the one or more communications gateway devices associated with the vehicle. The audio data or image data is received within a predetermined amount of time from the audio data or image data being collected at the vehicle. In some embodiments, the method further includes transmitting, to the one or more communications gateway devices associated with the vehicle, timing information configured to control collection of sensor data at the vehicle.

In yet another exemplary aspect, a system for operating an autonomous vehicle, comprising a computer that includes a processor configured to perform the methods or operations described in this patent document.

In yet another exemplary aspect, the methods or operations described in this patent document are embodied in a non-transitory computer readable storage medium. The non-transitory computer readable storage medium includes code that when executed by a processor, causes the processor to perform the methods described in this patent document.

In another exemplary embodiment, a device that is configured or operable to perform the methods or operations described herein is disclosed. In yet another exemplary embodiment, a system comprises a computer located in a vehicle, the computer comprises a processor configured to implement the methods described herein is disclosed.

The above and other aspects and their implementations are described in greater detail in the drawings, the descriptions, and the claims.

### BRIEF DESCRIPTION OF THE DRAWINGS

For a more complete understanding of this disclosure, reference is now made to the following brief description, taken in connection with the accompanying drawings and detailed description, where like reference numerals represent like parts.

FIG. 1 illustrates a block diagram of an example vehicle ecosystem of an autonomous vehicle.

FIG. 2 shows a flow diagram for safe operation of an autonomous vehicle safely in light of the health and/or surroundings of the autonomous vehicle.

FIG. 3 illustrates a system that includes one or more autonomous vehicles, a control center or oversight system with a human operator (e.g., a remote center operator (RCO)), and an interface for third-party interaction.

FIG. 4 shows an exemplary block diagram of a remote computer associated with an oversight system, a control tower, a control center, and/or the like.

FIG. 5 provides an overview diagram of a communications gateway device configured to enable communication between an autonomous vehicle and an oversight system.

FIG. 6 illustrates an example redundant gateway configuration that includes two or more communications gateway devices.

FIG. 7 illustrates another example redundant gateway configuration that includes two or more communications gateway devices.

FIG. 8 illustrates another example redundant gateway configuration that includes two or more communications gateway devices.

FIG. 9 illustrates another example redundant gateway configuration that includes two or more communications gateway devices.

FIG. 10 illustrates a diagram of an example implementation of a communications gateway device.

FIG. 11 illustrates a diagram of another example implementation of a communications gateway device.

FIG. 12 illustrates a diagram of another example implementation of a communications gateway device.

FIG. 13 illustrates a diagram of another example implementation of a communications gateway device.

FIG. 14 illustrates a diagram of an example implementation of a plurality of communications gateway devices.

FIG. 15 is a flowchart of an example method implemented by a remote computer.

### DETAILED DESCRIPTION

Vehicles traversing highways and roadways are legally required to comply with regulations and statues in the course of safe operation of the vehicle. For autonomous vehicles (AVs), particularly autonomous tractor trailers, the ability to recognize a malfunction in its systems and stop safely can allow for a lawful and safe operation of the vehicle. Described below in detail are systems and methods for the safe and lawful operation of an autonomous vehicle on a roadway, including the execution of maneuvers that bring the autonomous vehicle in compliance with the law while signaling surrounding vehicles of its condition.

This patent document describes in Section I below an example vehicle ecosystem of an autonomous vehicle and driving related operations of the autonomous vehicle. Section II describes a control center or oversight system for one or more autonomous vehicles, as well as various example features thereof, and operations/processes performed thereby. Sections III and IV describe communications gateway devices for an autonomous vehicle and operations performed by the autonomous vehicle related to the communications gateway devices. The example headings for the various sections below are used to facilitate the understanding of the disclosed subject matter and do not limit the scope of the claimed subject matter in any way. Accordingly, one or more features of one example section can be combined with one or more features of another example section.

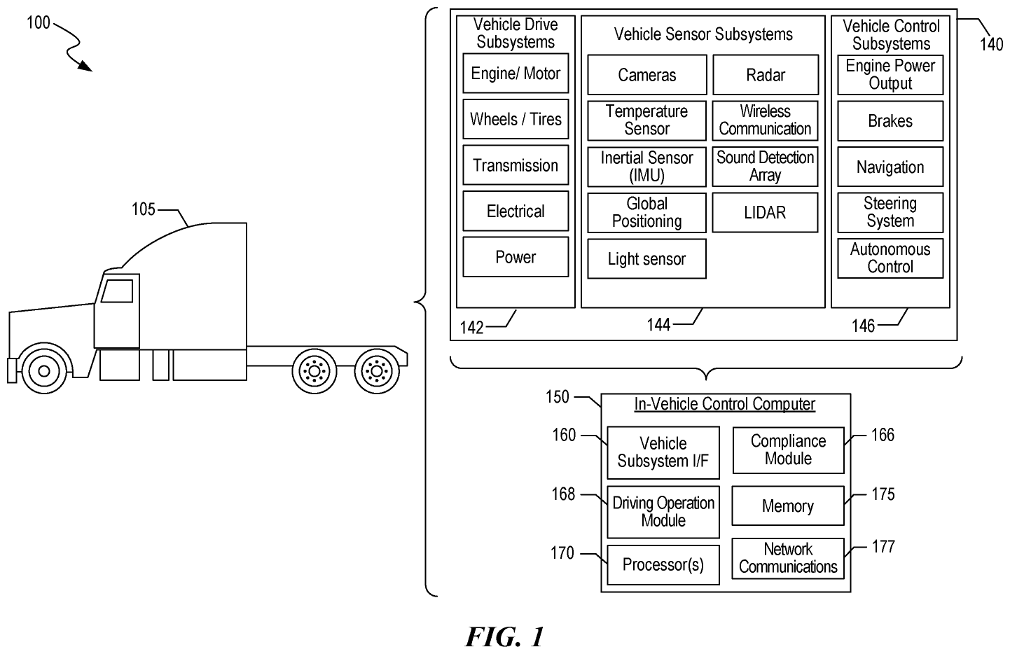

This patent document uses many abbreviations and uncommon terms. For instance, “GNSS” or “GPS” may refer to satellite navigation systems; when referring to an emergency vehicle, such as a police vehicle, ambulance, fire truck, tow truck, and the like, the abbreviation “EV” may be used; the acronym “TTC” indicates “time to collision”; “NPC” refers to non-player characters and may include any other vehicle that is not the autonomous vehicle in FIG. 1. For example, any surrounding vehicle, motorcycle, bicycle, and the like that are manually driven or autonomously driven and that may not be in communication with the autonomous vehicle may be considered NPC; a “k-ramp” denotes a freeway on/off ramp of a particular configuration; “STV” indicates a stopped vehicle; “ELV” may indicate an end-of-life or disabled vehicle, such as a disabled vehicle on a roadside; “OBO” may refer to an on-board operator or a human operator of an autonomous vehicle who temporarily takes control to assist during inspections, start-up, and/or ending of a trip or mission for the autonomous vehicle; and “LC” may be an abbreviation for lane change.

### I. Example Ecosystem of an Autonomous Vehicle

FIG. 1 shows a system 100 that includes an autonomous vehicle 105. The autonomous vehicle 105 may include a tractor of a semi-trailer truck. The autonomous vehicle 105 includes a plurality of vehicle subsystems 140 and an in-vehicle control computer 150. The plurality of vehicle subsystems 140 includes vehicle drive subsystems 142, vehicle sensor subsystems 144, and vehicle control subsystems 146. An engine or motor, wheels and tires, a transmission, an electrical subsystem, and a power subsystem may be included in the vehicle drive subsystems. The engine of the autonomous truck may be an internal combustion engine, a fuel-cell powered electric engine, a battery powered electrical engine, a hybrid engine, or any other type of engine capable of moving the wheels on which the autonomous vehicle 105 moves. The autonomous vehicle 105 may have multiple motors or actuators to drive the wheels of the vehicle, such that the vehicle drive subsystems 142 include two or more electrically driven motors. The transmission may include a continuous variable transmission or a set number of gears that translate the power created by the engine into a force that drives the wheels of the vehicle. The vehicle drive subsystems may include an electrical system that monitors and controls the distribution of electrical current to components within the system, including pumps, fans, and actuators. The power subsystem of the vehicle drive subsystems may include components that regulate the power source of the vehicle.

Vehicle sensor subsystems 144 can include sensors for general operation of the autonomous vehicle 105, including those which would indicate a malfunction in the autonomous vehicle or another cause for an autonomous vehicle to perform a limited or minimal risk condition (MRC) maneuver or an emergency driving maneuver. A driving operation module (shown as 168 in FIG. 1) can perform an MRC maneuver by sending instructions that cause the autonomous vehicle to steer along a trajectory to a side of the road and to apply brakes so that the autonomous vehicle can be safely stopped to the side of the road. The sensors for general operation of the autonomous vehicle may include cameras, a temperature sensor, an inertial sensor (IMU), a global positioning system, a light sensor, a LIDAR/LiDAR system, a radar system, and wireless communications.

A sound detection array, such as a microphone or array of microphones, may be included in the vehicle sensor subsystem 144. The microphones of the sound detection array are configured to receive audio indications of the presence of, or instructions from, authorities, including sirens and command such as “Pull over.” These microphones are mounted, or located, on the external portion of the vehicle, specifically on the outside of the tractor portion of an autonomous vehicle 105. The microphones may be any suitable type, mounted such that they are effective both when the autonomous vehicle 105 is at rest, as well as when it is moving at driving speeds.

Cameras included in the vehicle sensor subsystems 144 may be rear facing, forward facing, and/or provide side views of the autonomous truck 105 so that lights from emergency vehicles may be observed from all around the autonomous truck 105. These cameras may include video cameras, cameras with filters for specific wavelengths, as well as other cameras suitable to detect emergency vehicle lights based on color, flashing, or of both color and flashing.

The vehicle control subsystems 146 may be configured to control operation of the autonomous vehicle, or truck, 105 and its components. Accordingly, the vehicle control subsystems 146 may include various elements such as an engine power output subsystem, a brakes unit, a navigation unit, a steering system, and an autonomous control unit. The engine power output may control the operation of the engine, including the torque produced or horsepower provided, as well as provide control the gear selection of the transmission. The brakes unit can include any combination of mechanisms configured to decelerate the autonomous vehicle 105. The brakes unit can use friction to slow the wheels in a standard manner. The brakes unit may include an Anti-lock brake system (ABS) that can prevent the brakes from locking up when the brakes are applied. The navigation unit may be any system configured to determine a driving path or route for the autonomous vehicle 105. The navigation unit may additionally be configured to update the driving path dynamically while the autonomous vehicle 105 is in operation. In some embodiments, the navigation unit may be configured to incorporate data from the GPS device and one or more pre-determined maps so as to determine the driving path for the autonomous vehicle 105. The steering system may represent any combination of mechanisms that may be operable to adjust the heading of autonomous vehicle 105 in an autonomous mode or in a driver-controlled mode.

The autonomous control unit may represent a control system configured to identify, evaluate, and avoid or otherwise negotiate potential obstacles in the environment of the autonomous vehicle 105. In general, the autonomous control unit may be configured to control the autonomous vehicle 105 for operation without a driver or to provide driver assistance in controlling the autonomous vehicle 105. In some embodiments, the autonomous control unit may be configured to incorporate data from the GPS device, the RADAR, the LiDAR, the cameras, and/or other vehicle subsystems to determine the driving path or trajectory for the autonomous vehicle 105. The autonomous control may activate systems of the autonomous vehicle 105, which may not be present in a conventional vehicle, including those systems which can allow an autonomous vehicle to communicate with surrounding drivers or signal surrounding vehicles or drivers for safe operation of the autonomous vehicle.

An in-vehicle control computer 150, which may be referred to as a VCU, includes a vehicle subsystem interface 160, a driving operation module 168, one or more processors 170, a compliance module 166, a memory 175, and a network communications subsystem 177. This in-vehicle control computer 150 controls many, if not all, of the operations of the autonomous vehicle 105 in response to information from the various vehicle subsystems 140. The one or more processors 170 execute the operations that allow the system to determine the health/status of the autonomous vehicle, such as whether the autonomous vehicle has a malfunction or has encountered a situation requiring service or a deviation from normal operation and giving instructions. Data from the vehicle sensor subsystems 144 is provided to VCU 150 so that the determination of the status of the autonomous vehicle can be made. The compliance module 166 determines what action should be taken by the autonomous vehicle 105 to operate according to the applicable (e.g., local) regulations. Data from the vehicle sensor subsystems 144 may be provided to the compliance module 166 so that the best course of action in light of the autonomous vehicle's status may be appropriately determined and performed. Alternatively, or additionally, the compliance module 166 may determine the course of action in conjunction with another operational or control module, such as the driving operation module 168.

The memory 175 may contain additional instructions as well, including instructions to transmit data to, receive data from, interact with, or control one or more of the vehicle drive subsystems 142, the vehicle sensor subsystems 144, and the vehicle control subsystems 146 including the autonomous Control system. The in-vehicle control computer (VCU) 150 may control the function of the autonomous vehicle 105 based on inputs received from various vehicle subsystems (e.g., the vehicle drive subsystems 142, the vehicle sensor subsystems 144, and the vehicle control subsystems 146). Additionally, the VCU 150 may send information to the vehicle control subsystems 146 to direct the trajectory, velocity, signaling behaviors, and the like, of the autonomous vehicle 105. For example, compliance module 166 and/or the driving operation module 168 in the VCU 150 may send instructions to one or more devices of the autonomous vehicle 105. The one or more devices may include one or more devices in the vehicle drive subsystems 142, the vehicle sensor subsystems 144, or the vehicle control subsystems 146. These instructions sent by the VCU 150 to one or more devices in the autonomous vehicle 105 are configured to effectuate and result in certain operations and actions being performed by the one or more devices in accordance with the instructions. Operations resulting from the instructions being sent to the one or more devices may together form driving related operations performed by the autonomous vehicle 105. For example, the VCU 150 may send instructions to a motor in the steering system, to an actuator in a brake unit, and/or to the engine to cause one or more devices to operate in accordance with the instructions such that the autonomous vehicle 105 performs a maneuver, or steers to follow a trajectory at a specified (e.g., via the instructions) velocity and/or acceleration/deceleration. Thus, the instructions provided by the VCU 150 can allow the autonomous vehicle 105 to follow a trajectory to steer from a current lane in which the autonomous vehicle 105 is operating to an adjacent lane or to a shoulder area (e.g., emergency stopping lane or area on side of the roadway) on the roadway. The autonomous control vehicle control subsystem may receive a course of action to be taken from the compliance module 166 of the VCU 150 and consequently relay instructions to other subsystems to execute the course of action. In Sections III to IV below, this patent document describes that the autonomous vehicle or a system performs certain functions or operations. These functions and/or the operations described can be performed by the compliance module 166 and/or the driving operation module 168.

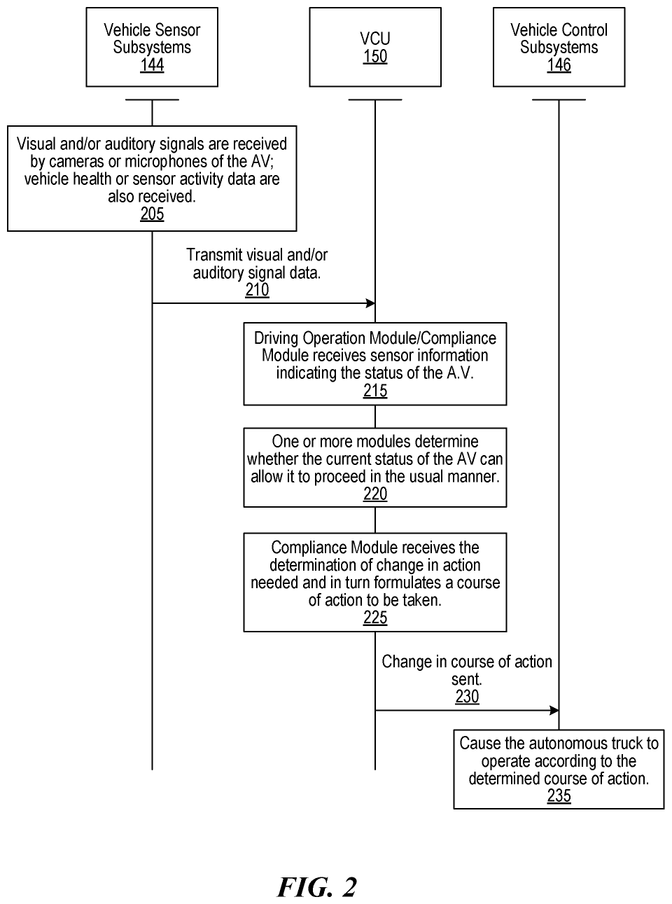

FIG. 2 shows a flow diagram for safe operation of an autonomous vehicle safely in light of the health and/or surroundings of the autonomous vehicle. Although this figure depicts functional steps in a particular order for purposes of illustration, the process is not limited to any particular order or arrangement of steps. One skilled in the relevant art will appreciate that the various steps portrayed in this figure may be omitted, rearranged, combined and/or adapted in various ways.

As shown in FIG. 2, the vehicle sensor subsystems 144 receives visual, auditory, or both visual and auditory signals indicating the at the environmental condition of the autonomous vehicle, as well as vehicle health or sensor activity data are received in step 205. These visual and/or auditory signal data are transmitted from the vehicle sensor subsystems 144 to the in-vehicle control computer system (VCU) 150, as in step 210. Any of the driving operation module and the compliance module receive the data transmitted from the vehicle sensor subsystems, in step 215. Then, one or both of those modules determine whether the current status of the autonomous vehicle can allow it to proceed in the usual manner or that the autonomous vehicle needs to alter its course to prevent damage or injury or to allow for service in step 220. The information indicating that a change to the course of the autonomous vehicle is needed may include an indicator of sensor malfunction; an indicator of a malfunction in the engine, brakes, or other components that may be necessary for the operation of the autonomous vehicle; a determination of a visual instruction from authorities such as flares, cones, or signage; a determination of authority personnel present on the roadway; a determination of a law enforcement vehicle on the roadway approaching the autonomous vehicle, including from which direction; and a determination of a law enforcement or first responder vehicle moving away from or on a separate roadway from the autonomous vehicle. This information indicating that a change to the autonomous vehicle's course of action or driving related operation is needed may be used by the compliance module to formulate a new course of action to be taken which accounts for the autonomous vehicle's health and surroundings, in step 225. The course of action to be taken may include slowing, stopping, moving into a shoulder, changing route, changing lane while staying on the same general route, and the like. The course of action to be taken may include initiating communications with any oversight or human interaction systems present on the autonomous vehicle. The course of action to be taken may then be transmitted from the VCU 150 to the autonomous control system, in step 230. The vehicle control subsystems 146 then cause the autonomous vehicle 105 to operate in accordance with the course of action to be taken that was received from the VCU 150 in step 235.

It should be understood that the specific order or hierarchy of steps in the processes disclosed herein is an example of exemplary approaches. Based upon design preferences, it is understood that the specific order or hierarchy of steps in the processes may be rearranged while remaining within the scope of the present disclosure. The accompanying method claims present elements of the various steps in a sample order and are not meant to be limited to the specific order or hierarchy presented.

### II. Autonomous Truck Oversight System

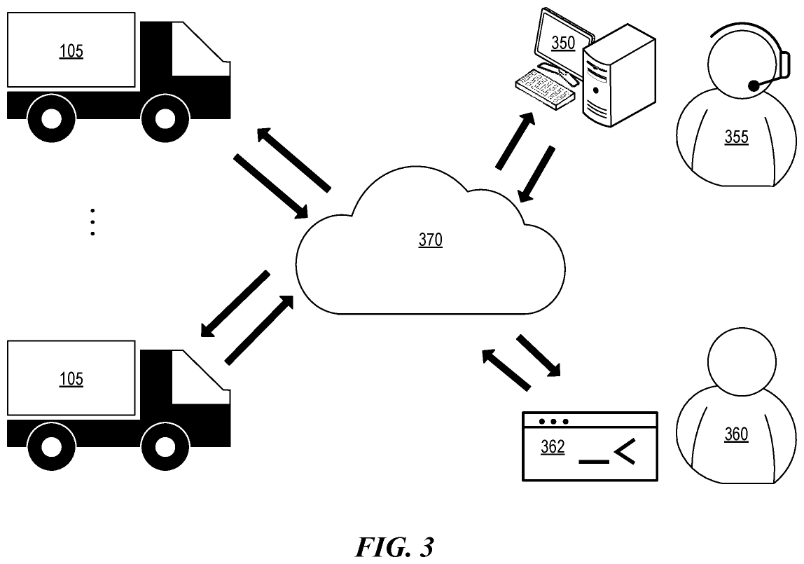

FIG. 3 illustrates a system that includes one or more autonomous vehicles 105, a control center or oversight system 350 with a human operator 355, and an interface 362 for third-party 360 interaction. A human operator 355 may also be known as a remoter center operator (RCO). Communications between the autonomous vehicles 105, oversight system 350 and user interface 362 take place over a network 370. In some instances, where not all the autonomous vehicles 105 in a fleet are able to communicate with the oversight system 350, the autonomous vehicles 105 may communicate with each other over the network 370 or directly with each other via an ad-hoc communication link. As described with respect to FIG. 1, the VCU 150 of each autonomous vehicle 105 may include a module for network communications 177.

An autonomous truck may be in communication with an oversight system. The oversight system may serve many purposes, including: tracking the progress of one or more autonomous vehicles (e.g., an autonomous truck); tracking the progress of a fleet of autonomous vehicles; sending maneuvering instructions to one or more autonomous vehicles; monitoring the health of the autonomous vehicle(s); monitoring the status of the cargo of each autonomous vehicle in contact with the oversight system; facilitate communications between third parties (e.g., law enforcement, clients whose cargo is being carried) and each, or a specific, autonomous vehicle; allow for tracking of specific autonomous trucks in communication with the oversight system (e.g., third-party tracking of a subset of vehicles in a fleet); arranging maintenance service for the autonomous vehicles (e.g., oil changing, fueling, maintaining the levels of other fluids); alerting an affected autonomous vehicle of changes in traffic or weather that may adversely impact a route or delivery plan; pushing over the air updates to autonomous trucks to keep all components up to date; and other purposes or functions that improve the safety for the autonomous vehicle, its cargo, and its surroundings. An oversight system may also determine performance parameters of an autonomous vehicle or autonomous truck, including any of: data logging frequency, compression rate, location, data type; communication prioritization; how frequently to service the autonomous vehicle (e.g., how many miles between services); when to perform a minimal risk condition (MRC) maneuver while monitoring the vehicle's progress during the maneuver; when to hand over control of the autonomous vehicle to a human driver (e.g., at a destination yard); ensuring an autonomous vehicle passes a pre-trip inspection; ensuring an autonomous vehicle performs or conforms to legal requirements at checkpoints and weight stations; ensuring an autonomous vehicle performs or conforms to instructions from a human at the site of a roadblock, cross-walk, intersection, construction, or accident; and the like.

Included in some of the functions executed by an oversight system or command center is the ability to relay over-the-air, real-time weather updates to autonomous vehicles in a monitored fleet. The over-the-air weather updates may be pushed to all autonomous vehicles in the fleet or may be pushed only to autonomous vehicles currently on a mission to deliver a cargo. Alternatively, or additionally, priority to push or transmit over-the- air weather reports may be given to fleet vehicles currently on a trajectory or route that leads towards or within a pre-determined radius of a weather event.

Another function that may be encompassed by the functions executed by an oversight system or command center is the transmission of trailer metadata to the autonomous vehicle's computing unit (VCU) prior to the start of a cargo transport mission. The trailer metadata may include the type of cargo being transmitted, the weight of the cargo, temperature thresholds for the cargo (e.g., trailer interior temperature should not fall below or rise above pre-determined temperatures), time-sensitivities, acceleration/deceleration sensitivities (e.g., jerking motion may be bad because of the fragility of the cargo), trailer weight distribution along the length of the trailer, cargo packing or stacking within the trailer, and the like.

An oversight system or command center may be operated by one or more human, also known as an operator or a remote center operator (RCO). The operator may set thresholds for autonomous vehicle health parameters, so that when an autonomous vehicle meets or exceeds a threshold, a precautionary action may be taken. Examples of vehicle health parameters for which thresholds may be established by an operator may include any of: fuel levels; oil levels; miles traveled since last maintenance; low tire-pressure detected; cleaning fluid levels; brake fluid levels; responsiveness of steering and braking subsystems; Diesel exhaust fluid (DEF) level; communication ability (e.g., lack of responsiveness); positioning sensors ability (e.g., GPS, IMU malfunction); impact detection (e.g., vehicle collision); perception sensor ability (e.g., camera, LIDAR, radar, microphone array malfunction); computing resources ability (e.g., VCU or ECU malfunction or lack of responsiveness, temperature abnormalities in computing units); angle between a tractor and trailer in a towing situation (e.g., tractor-trailer, 18-wheeler, or semi-truck); unauthorized access by a living entity (e.g., a person or an animal) to the interior of an autonomous truck; and the like. The precautionary action may include execution of a minimal risk condition (MRC) maneuver, seeking service, or exiting a highway or other such re-routing that may be less taxing on the autonomous vehicle. An autonomous vehicle whose system health data meets or exceeds a threshold set at the oversight system or by the operator may receive instructions that are automatically sent from the oversight system to perform the precautionary action.

The operator may be made aware of situations affecting one or more autonomous vehicles in communication with or being monitored by the oversight system that the affected autonomous vehicle(s) may not be aware of. Such situations may include: irregular or sudden changes in traffic flow (e.g., traffic jam or accident); abrupt weather changes; abrupt changes in visibility; emergency conditions (e.g., fire, sink-hole, bridge failure); a power outage affecting signal lights; an unexpected road work; large or ambiguous road debris (e.g., object unidentifiable by the autonomous vehicle); law enforcement activity on the roadway (e.g., car chase or road clearing activity); and the like. These types of situations that may not be detectable by an autonomous vehicle may be brought to the attention of the oversight system operator through traffic reports, law enforcement communications, data from other vehicles that are in communication with the oversight system, reports from drivers of other vehicles in the area, and similar distributed information venues. An autonomous vehicle may not be able to detect such situations because of limitations of sensor systems or lack of access to the information distribution means (e.g., no direct communication with a weather agency). An operator at the oversight system may push such information to affected autonomous vehicles that are in communication with the oversight system. The affected autonomous vehicles may proceed to alter their route, trajectory, or speed in response to the information pushed from the oversight system. In some instances, the information received by the oversight system may trigger a threshold condition indicating that MRC (minimal risk condition) maneuvers are warranted; alternatively, or additionally, an operator may evaluate a situation and determine that an affected autonomous vehicle should perform an MRC maneuver and subsequently send such instructions to the affected vehicle. In these cases, each autonomous vehicle receiving either information or instructions from the oversight system or the oversight system operator may use its on-board computing unit (e.g., VCU) to determine how to safely proceed, including performing an MRC maneuver that includes pulling-over or stopping.

Other interactions that the remote center operator (RCO) may have with an autonomous vehicle or a fleet of autonomous vehicles includes any of the following: pre-planned event avoidance; real-time route information updates; real-time route feedback; trail hookup status; first responder communication request handling; notification of aggressive surrounding vehicle(s); identification of construction zone changes; status of an autonomous vehicle with respect to its operational design domain (ODD), such as alerting the RCO when an autonomous vehicle is close to or enters a status out of ODD; RCO notification of when an autonomous vehicle is within a threshold distance from a toll booth and appropriate instruction/communication with the autonomous vehicle or toll authority may be sent to allow the autonomous vehicle to bypass the toll; RCO notification of when an autonomous vehicle bypasses a toll; RCO notification of when an autonomous vehicle is within a threshold distance from a weigh station and appropriate instruction/communication with the autonomous vehicle or appropriate authority may be sent to allow the autonomous vehicle to bypass the weigh station; RCO notification of when an autonomous vehicle bypasses a weigh station; notification to the autonomous vehicle from the RCO regarding scheduling or the need for fueling or maintenance; RCO authorization of third-party access to an autonomous vehicle cab; ability of an RCO to start/restart an autonomous driving system (ADS) on a vehicle; ability of an administrator (possibly an RCO) to set roles for system users, including ground crew, law enforcement, and third parties (e.g., customers, owners of the cargo); support from an RCO for communication with a service maintenance system with fleet vehicles; notification to the RCO from an autonomous vehicle of acceleration events; instruction from an RCO to an autonomous vehicle to continue its mission even when communication is interrupted; RCO monitoring of an autonomous vehicle during and after an MRC maneuver is executed; support for continuous communication between an autonomous vehicle and a yard operator at a facility where the autonomous vehicle is preparing to begin a mission or where the autonomous vehicle is expected to arrive; oversight system monitoring of software systems on an autonomous vehicle and oversight system receiving alerts when software systems are compromised; and the like.

An oversight system or command center may allow a third party to interact with the oversight system operator, with an autonomous truck, or with both the human system operator and an autonomous truck. A third party may be a customer whose goods are being transported, a law enforcement or emergency services provider, or a person assisting the autonomous truck when service is needed. In its interaction with a third party, the oversight system may recognize different levels of access, such that a customer concerned about the timing or progress of a shipment may only be allowed to view status updates for an autonomous truck, or may be able to view status and provide input regarding what parameters to prioritize (e.g., speed, economy, maintaining originally planned route) to the oversight system. By providing input regarding parameter prioritization to the oversight system, a customer can influence the route and/or operating parameters of the autonomous truck.

Actions that an autonomous vehicle, particularly an autonomous truck, as described herein may be configured to execute to safely traverse a course while abiding by the applicable rules, laws, and regulations may include those actions successfully accomplished by an autonomous truck driven by a human. These actions, or maneuvers, may be described as features of the truck, in that these actions may be executable programming stored on the VCU 150 (the in-vehicle control computer unit). For example, the VCU 150 performs operations including those related to reactions to the detection of certain types of conditions or objects such as: appropriate motion on hills; appropriate motion on curved roads, appropriate motion at highway exits; appropriate motion or action in response to: detecting one or more stopped vehicle, detecting one or more vehicles in an emergency lane; detecting an emergency vehicle with flashing lights that may be approaching the autonomous vehicle; motion in response to detecting one or more large vehicles approaching, adjacent to, or soon, to be adjacent to the autonomous vehicle; motions or actions in response to pedestrians, bicyclists, and the like after identification and classification of such actors (e.g., by the VCU 150); motions or actions in response to curved or banked portions of the roadway; and/or motions in response to identifying on and off ramps on highways or freeways, encountering an intersection; execution of a merge into traffic in an adjacent lane or area of traffic; detection of a need to clean one or more sensors and the cleaning of the appropriate sensor(s); identification of law enforcement/emergency vehicles and personnel and compliance with associated instructions or regulations; execution of minimal risk condition maneuvers when needed; and identification of road debris or unknown objects; and the like. Other features of an autonomous truck may include those actions or features which are needed for any type of maneuvering, including that needed to accomplish the features or actions that are reactionary, listed above.

Supporting features may include: changing lanes safely; operating turn signals on the autonomous truck to alert other drivers of intended changes in motion; biasing the autonomous truck in its lane (e.g., moving away from the center of the lane to accommodate the motions or sizes of neighboring vehicles or close objects); ability to maintain an appropriate following distance; the ability to turn right and left with appropriate signaling and motion, and the like. Supporting features may also include: the ability to navigate roundabouts; the ability to properly illuminate with on-vehicle lights as-needed for ambient light and for compliance with local laws; apply the minimum amount of deceleration needed for any given action; determine location at all times; adapting dynamic vehicle control for trailer load distributions, excluding wheel adjustment; launching (reaching target speed), accelerating, stopping, and yielding; operate on roadways with bumps and potholes; enter a minimal risk condition (MRC) on roadway shoulders; access local laws and regulations based on location along a route; operate on asphalt, concrete, mixed grading, scraped road, and gravel; ability to operate in response to metering lights/signals at on-ramps; operate on a roadway with a width up to a pre-determined width; able to stop at crosswalks with sufficient stopping distance; navigate two-way left turn lanes; operate on roadways with entry and exit ramps; utilize the vehicle horn to communicate with other drivers; , and the like. One or more features and/or one or more supporting features described in this patent document may combined and can be performed by the in-vehicle control computer in an autonomous truck.

In some embodiments, the actions or features may be considered supporting features and may include: speed control; the ability to maintain a straight path; and the like. These supporting features, as well as the reactionary features listed above, may include controlling or altering the steering, engine power output, brakes, or other vehicle control subsystems 146. The reactionary features and supporting features listed above are discussed in greater detail below.

As described above, an autonomous vehicle may be in communication with an oversight system which may serve various purposes related to the operation of the autonomous vehicle, such as but not limited to monitoring and/or triggering MRC fault conditions.

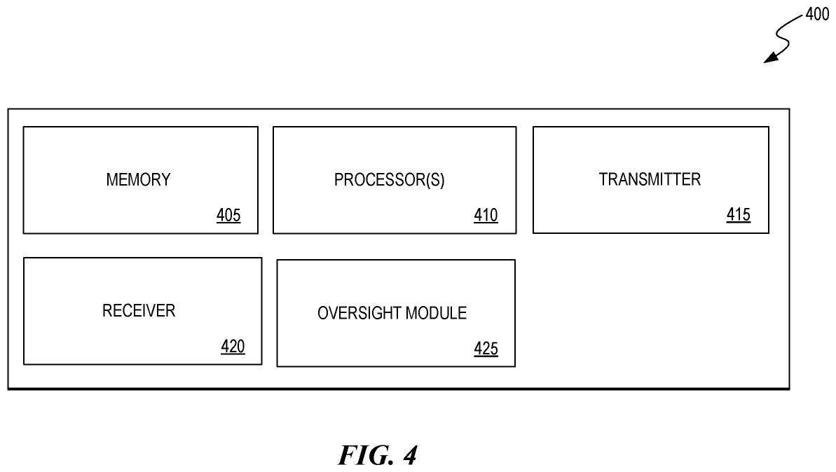

FIG. 4 shows an exemplary block diagram of a remote computer 400 associated with an oversight system. The oversight system (shown as 350 in FIG. 3) may include the remote computer 400 which can be located at a location outside of an autonomous vehicle. In this patent document, the descriptions related to operations performed by the oversight system can be performed by the oversight module (shown as 425 in FIG. 4) in the remote computer 400. The remote computer 400 includes at least one processor 410 and a memory 405 having instructions stored thereupon. The instructions, upon execution by the processor 410, configure the remote computer 400 to perform the operations related to the oversight module 425, where the oversight module 425 can perform operations related to the oversight system as described at least in FIGS. 1 to 3 and in the various embodiments described in this patent document. A remote computer 400 may include one or more servers. The transmitter 415 transmits or sends information or data to one or more autonomous vehicles, and the receiver 420 receives information or data from one or more autonomous vehicles. According to various embodiments, the information or data transmitted to and received from one or more autonomous vehicles may include communications, operations, processes, and the like described herein.

It will be understood that, in some embodiments, the remote computer 400 may be a cloud computing platform or a multi-processor platform. For example, the processor 410 includes a plurality of processors. As such, in some embodiments, the remote computer 400 includes a plurality of computing devices that may be located at different locations and that cooperate to perform functionalities associated with the remote computer 400.

In some embodiments, the processor 410 is configured to perform operations according to instructions stored upon the memory 405. For example, in some embodiments, the processor 410 is configured to perform operations including determining an instructional data for a vehicle of the plurality of vehicles based on data previously received from one or more of the plurality of vehicles; identifying one or more communications gateway devices associated with the vehicle; and transmitting the instructional data to each of the one or more communications gateway devices associated with the vehicle. In some embodiments, the remote computer 400 stores a unique identifier associated with each of the one or more communications gateway devices associated with a given vehicle. Accordingly, to communicate with the given vehicle, the remote computer 400 is configured to transmit data to each communications gateway device of the given vehicle using the unique identifiers. For example, the unique identifiers include network addresses of the communications gateway devices.

In some embodiments, the processor 410 is configured to perform operations including determining an instructional data for a vehicle of the plurality of vehicles based on data previously received from one or more of the plurality of vehicles; identifying one or more communications gateway devices associated with the vehicle; and transmitting the instructional data to each of the one or more communications gateway devices associated with the vehicle.

In some embodiments, the instructional data is configured to (i) be provided by the one or more communications gateway devices to a control computer located on the vehicle, and (ii) cause an operation of the vehicle. In some embodiments, the data that is previously received is received from one or more communications gateway devices for each of the one or more vehicles, and the data comprises sensor data collected from a sensor subsystem of each of the one or more vehicles. In some embodiments, the processor 410 is further configured to perform an operation for, in response to the instructional data including a streaming request, receiving audio data or image data from the one or more communications gateway devices associated with the vehicle. The audio data or image data is received within a predetermined amount of time from the audio data or image data being collected at the vehicle. In some embodiments, the processor 410 is further configured to perform an operation for transmitting, to the one or more communications gateway devices associated with the vehicle, timing information configured to control collection of sensor data at the vehicle.

### III. Example Communications Gateway

Some embodiments of system configurations or implementations for an autonomous vehicle communications gateway are described herein. Included herein are example configurations or implementations for the hardware architecture, interfaces, operational, functional performance, safety, and electromagnetic interference/electromagnetic compatibility (EMI/EMC) specifications related to an AV communications gateway. Embodiments described herein provide example bases for the allocation of component implementations to the lowest level system configuration items and the interfaces between those configuration items. According to some embodiments, a communications gateway may allow for communication between an oversight system (e.g., a remote computer 400 of an oversight system) and one or more autonomous vehicles. In some embodiments, a communications gateway of an autonomous vehicle provides a high throughput, reliable, and secured communication network between one or more in-vehicle systems (e.g., the autonomous driving system) and the oversight system.

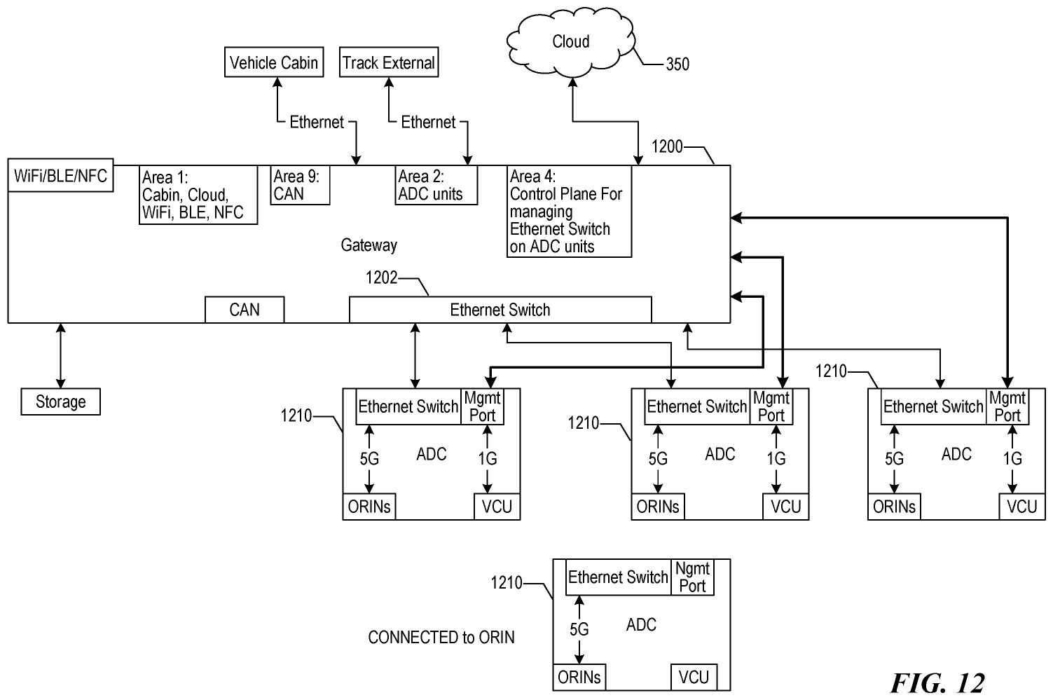

In some embodiments, a communications gateway is configured to directly interface with autonomous domain controller (ADC) units and components and to provide storage to record sensor data (as shown in FIGS. 12-14 and disclosed below). The ADC units form the autonomous system of the vehicle and each performing a specific role such as perception or sensor data collection. Each of the ADC units communicates with other ADC units, the communications gateway, the VCU, and the oversight system, and each ADC unit is configured to read and write to a memory device of the vehicle. In some embodiments, the ADC units correspond to vehicle subsystems, such as those shown in FIG. 1. For example, each subsystem shown in FIG. 1 directly interfaces with a communication gateway.

In some embodiments, each autonomous vehicle may be equipped with one or more communications gateways. The communications gateway may have the ability to do any of the following: allow for AV to oversight system communication (i.e., V2C) and the oversight system to AV communication (C2V); allow for two or more reliable and secured ways to communicate data from the vehicle to the oversight system or remote data storage (e.g., cloud storage) and vice versa; allow for AV to AV communications (V2V); transmit information indicating an availability, status, health, or the like of the communications gateway; acknowledge received communications (e.g., via transmitting acknowledgment messages or responses to an oversight system); ensure security around remote commands between the AV and the oversight system; convey the AV's location reliably at set time intervals; enable the oversight system to ping the AV for location and vehicle health status; allow for streaming of various sensor data directly to the command or oversight system (e.g., transmitting sensor data, image data, audio data within a predetermined amount of time of the data being collected by sensors); allow for automated alerts between the AV and oversight system; comply with ISO 21434 standards; support bi-directional, prioritized data flow between the AV and remote data storage/oversight system; support the secure issuance and receipt of MRC (minimum risk condition) maneuver commands; allow oversight system RCO access to essential AV system data to allow for uninterrupted AV operation; registration of the gateway; commercial-grade physical/environmental robustness; provide for the ability for third-party applications to co-exist in the system; the ability to utilize existing AV power or providing its own power supply separate from regular vehicle generated power; have a minimum of antennae; have the ability to store and forward logs and traces; support secured termination and remote routing-based configuration of the gateway; support high-accuracy, location-based information to be sent to oversight; have sufficient storage capacity for essential communications; be capable of satellite communications; be able to support roadside assistance solutions; and the like.

The oversight system may be able to issue minimum risk control or condition (MRC) commands and the autonomous vehicle system will in turn communicate back to the oversight system information about the mission it is executing (e.g., the route, the load being carried, the departure time, the load weight, the fueling needs, the client or third parties, the expected arrival time), and this information may be exchanged via communications such as through a communications gateway. The communications gateway may be configured to prioritize communications related to MRC commands, including communications related to the status of the execution of an MRC maneuver or command. Systems on an autonomous vehicle, including a communications gateway, may allow for: a constant or near constant availability of V2C/C2V communication path; access of the oversight system to the cab of an autonomous vehicle; pushed health updates from the autonomous vehicle to the oversight system and/or an authorized third party; any specific query of an authorized remote control operator (RCO); use of cryptographic technologies and supporting technologies (e.g., near-field communication (NFC)); update of a communications gateway at least partially locally; update of a communications gateway at least partially over the air securely; the ability for the communications gateway to act as a client to standardized services supporting secured remote access to the autonomous vehicle; the ability for the communications gateway to store drive profiles; and the ability for the communications gateway to store external communication device profiles.

In autonomous vehicles equipped with one or more communications gateways, each communications gateway may have at least one of the following security features: a hardware security module/secure enclave with fusible secrets; a trusted relationship between the communications gateway and an auxiliary power unit (APU) (e.g., one or more communications gateways are connected to an auxiliary power unit, a communications gateway is connected to one or more auxiliary power units); the ability to maintain separate domains securely; the ability to cache and manage vehicle entitlements; the ability to differentiate multiple roots of trust/trust hierarchies; the ability to securely pair with a proprietary oversight interface when the gateway is in “factory mode” or its default settings; the ability to secure its own key material (e.g., key material including communication credentials, identifiers, sensitive information, and/or the like); the ability to act as a hardware security module for an operating system and application level key material; the ability to support a secure boot via separate secrets to protect the AV system; the software may be signed and integrity measured; the internal process controls may be securely monitored and controlled; controller area network (CAN/FD-CAN) connections may be managed in a way to defend against external attacks; external connections may be managed to defend against compromise of the system; local physical storage encryption; a mechanism to strictly bound resources to prevent external attacks or compromise of the system; provide a secure internal message bus to exchange data within the gateway and AV system; the ability to rotate all key material with differentiated levels of access to each secret; full configuration management of commands may be made remotely for minimum risk condition (MRC) maneuvers; commands for MRC maneuvers may be encrypted and signed by appropriate keys; privacy requirements assigned by the communications gateway may be determined by the data; the communications gateway may vary the level of security to provide the right level of security during use; access point name (APN) security features may be evaluated and enabled based on use case; SIM cards may be verified for security vulnerabilities; a communication module may not be used as a way to drain vehicle battery to cause denial of service situation; a device secret may not be shared cross fleet; and the like.

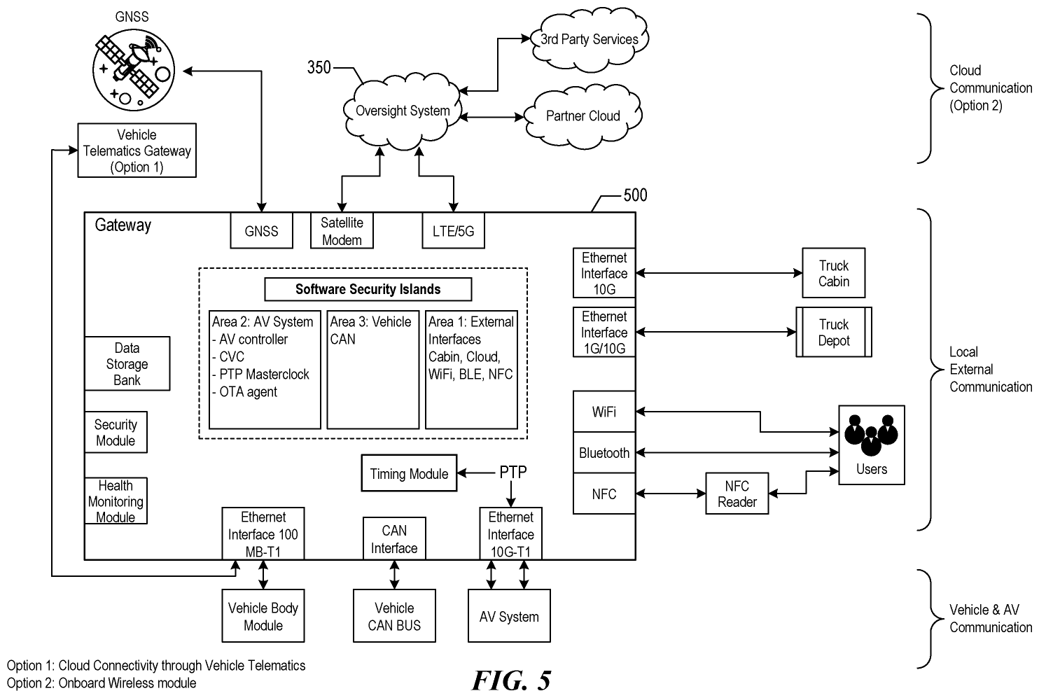

FIG. 5 provides a diagram showing a high-level view of an example communications gateway architecture. As illustrated in FIG. 5, an example gateway 500 may include various components including: a host processor; a hardware security module; an ethernet switch; a CAN interface; a WiFi module; a Bluetooth Low Energy (BLE) module; a satellite modem; a cellular communications module (e.g., enabling LTE communications, 5G communications, or the like); a NFC module; a timing module; storage; audio streaming components; video streaming components; security accelerators; external watchdog; global navigation satellite system (e.g., a global positioning system); V2X (vehicle to everything) wireless components; and health monitoring components. In some embodiments, the streaming components are configured for transmitting audio data or video data to a remote computer within a predetermined amount of time of the audio data or video data being collected. In some embodiments, the audio data or video data is streamed in response to a request or instruction received from the remote computer for the data to be streamed.

As further illustrated in FIG. 5, a communications gateway 500 enables cloud communication between an autonomous vehicle and an oversight system 350, local external communication (e.g., with manufacturing operators, testing operators, maintenance operators, mission operators), and communications within and along the vehicle (e.g., between an autonomous driving system and various controllers, sensors, devices, or the like).

Accordingly, in some embodiments, the communications gateway 500 includes a first module configured to wirelessly communicate data between a computer located in the vehicle and a remote-control computer located at a remote location outside of the vehicle (e.g., oversight system 350). In some embodiments, the first module includes a satellite modem and/or a cellular communications module (e.g., configured for LTE/5G communications), as illustrated in FIG. 5.

In some embodiments, a loss of communication with a remote computer via the first module results in an MRC maneuver being performed by the autonomous vehicle. For example, the VCU of the vehicle may receiving information, from the communications gateway device that indicates an error, interruption, loss, unavailability, and/or the like of wireless communication with the remote computer via the first module. For example, the information may be received based on the gateway device determining that a response signal, ping signal, and/or the like has not been received from the remote computer via the first module for at least a predetermined length of time. As another example, the information may be received based on the gateway device determining that a channel, a network, and/or the like used for communicating with the remote computer is unavailable.

Responsive to the information, the VCU determines a trajectory for the vehicle to reach a complete stop or a minimal risk condition (MRC). Instructions are then transmitted by the VCU via the gateway device to subsystems located in or on the vehicle to cause the vehicle to operate in accordance with the trajectory.

In some embodiments, the communications gateway 500 includes a second module configured to communicate data between the computer located in the vehicle and one or more devices located within a local area of the vehicle. For example, the second module is configured for WiFi communication, Bluetooth communication, near-field communication (NFC), and one or more Ethernet interfaces, as illustrated in FIG. 5. The local devices include physical key devices for accessing the vehicle, toll systems near which the autonomous vehicle may operate, a maintenance device that may be used by a maintenance operator near the autonomous vehicle, an inspection device or law enforcement device used by an inspection entity or law enforcement entity near the autonomous vehicle, a warehouse system that manages cargo loading for the autonomous vehicle, and/or the like.

For example, the communications gateway 500 detects, via the second module, a presence of a physical key device near the vehicle based on NFC data being exchanged between the second module and the physical key device. Responsive to the presence of the physical key device being detected, access to an interior portion of the vehicle is granted. For example, an operator presents the physical key device near a cabin door of the vehicle and is granted access to the vehicle cabin based on the detection of the physical key device via the second module of the communications gateway 500.

In some embodiments, the communications gateway 500 includes a third module configured to communicate data between the computer located in the vehicle and one or more subsystems located in or on the vehicle. For example, the third module is configured to enable communications between a VCU and a plurality of sensor subsystems, drive subsystems, power subsystems, and/or the like via a CAN interface, ethernet interfaces, and/or the like, as illustrated in FIG. 5. In some embodiments, the VCU is configured to perform operations including receiving, from the communications gateway device, information that indicates an error, interruption, or unavailability of wireless communication with the remote computer via the first module; determining a trajectory for the vehicle to reach a complete stop based on receiving sensor data that was obtained via the third module; and transmitting, via the third module, instructions to the subsystems located in or on the vehicle to cause the vehicle to operate in accordance with the trajectory.

In some embodiments, the third module is configured to communicate with a plurality of autonomous domain controllers of an autonomous system, each autonomous domain controller corresponding to an autonomous function such as perception, sensor data collection, and/or the like. For example, the VCU includes a plurality of autonomous domain controllers each configured to interface with the communications gateway 500 via the third module.

In particular, the communications gateway 500 is configured to store sensor data (e.g., audio data, image data) collected by an audio sensor or a camera of a sensor subsystem in real-time. For example, in some embodiments, the gateway stores sensor data within a predetermined time of the sensor data being collected by the sensor subsystem. In some embodiments, the gateway is configured to stream the sensor data to an oversight system, such that the sensor data is transmitted to the oversight system within a predetermined time of the sensor data being collected. The gateway may stream sensor data in response to a request or instruction received from the remote computer.

In some embodiments, a communications gateway 500 is configured and used to communicate with the oversight system that is remote from the autonomous vehicle. In some embodiments, the communications gateway device includes a plurality of sub-modules, including a cellular communication sub-module (e.g., configured for LTE/5G), a Wi-Fi and Bluetooth sub-module, a satellite sub-module or a GNSS/GPS sub-module, a security sub-module, and an ethernet sub-module.

As shown in FIG. 5, the communications gateway 500 may include a plurality of software security islands, environments, enclaves, and/or the like. In some embodiments, each software security island or environment corresponds to a different module of the gateway and is used to process, store, and/or the like data that is transmitted or received via the corresponding module. In some embodiments, the plurality of software security environments includes a first environment for external interfacing, a second environment for autonomous operations, and a third environment for in-vehicle communications with vehicle subsystems.

IV.(a) Exemplary Descriptions

| Term/ | |
|---|---|
| Abbreviation | Example Description |
| L4 system | SAE Level 4 Automated Driving System (SAE J30168) |
| L2 system | SAE Level 2 Automated Driving System (SAE J30168) |
| HMI | Human Machine Interface |
| ADS | Autonomous Driving System |
| OBO | On-Module/On-Board Operator |
| CVC | Central Vehicle Computer |
| SoC | High performance system-on-chip processor (e.g., Orin-X) |
| OEM | Original equipment manufacturer. This may refer to a |
| | company, entity, or the like that is a manufacturer of |
| | one or more components of a conventional vehicle which |
| | may be converted to an autonomous vehicle, or the |
| | manufacturer of one or more components of a vehicle that |
| | may be fitted with an autonomous driving system (ADS). |

IV.(b) Example Gateway Hardware-Implemented Features

In some embodiments, a communications gateway may include one or more multi-core processors. For example, the one or more multi-core processors may include ARM processors or the like. In some embodiments, the one or more multi-core processors may be configured to support at least the following features: multiple central processing unit (CPU) cores, running above 1 GHz; 8 MB to 64 MB cache; one or more dynamic random-access memory (DRAM) chips having a capacity of 256 GB; a packet caching buffer for packets of a suitable size (e.g., 2 MB); multiple serializer/deserializer lanes, operation up to a suitable speed in GHz; multiple Ethernet ports; multiple Ethernet speeds; high-performance data path accelerators; multiple PCIe Gen4 lanes; at least one security accelerator of suitable speed; a data compression/decompression engine; multiple SATA3.0 connections; secure boot and execution environment technology; multiple ports including SD, eMMC, DUART, I2C, USB3.0, CAN, FD-Can, or the like; IPv4 and IPv6; and compliance with IEEE 1588.

In some embodiments, a communications gateway may include one or more Ethernet switches, and the communications gateway may provide fast Ethernet Links to internal and external data networking. In some embodiments, the Ethernet switches may support at least the following: an interface of any suitable Gbps; conformance with IEEE 802.3; line-rate performance when handling a throughput of tens of Gbits/s; any suitable network; and cable lengths of tens of meters. In some embodiments, the Ethernet switches may be managed switches. In some embodiments, the Ethernet switches include transceivers that comply with IEEE 802.3 and support any of IEEE 802.1xx standards. In some embodiments, the Ethernet switches may connect to a control processor for software updates, policy updates, or the like.

In some embodiments, a communications gateway may include a controller area network (CAN) interface which may include a CAN bus. The CAN bus may be a native interface to the host processor or be supported on a different microcontroller. If the CAN interface is supported on a microcontroller, it may connect to the host processor through serial peripheral interface (SPI) or peripheral component interconnect express (PCIe).

In some embodiments, the communications gateway may support multiple CAN interfaces. The communications gateway may listen on the CAN bus and log all messages when logging is enabled. The gateway may provide multiple SAE J1939 compatible communications interfaces, which may comply with electrical and functional characteristics called out in the J1939 series of specifications, subject to the OEM requirements.

In some embodiments, the communications gateway includes a Wi-Fi module that may support at least the following features: connection to the host processor through encrypted means; self-contained SOC with integrated TCP/IP stack based connectivity protocols along with SSL support; Fast Wake-up and Start-up; compatibility or conformance with current or previous applicable IEEE Wi-Fi standards; Integrated Chip Antenna or suitable Connector for an External Antenna; Advanced Carrier and Timing Synchronization; software-enabled access points; compatibility with current or previous IEEE Wi-Fi standards for various types of password protection; suitable media access control throughput; on-chip memory management engine to reduce the host load; Wi-Fi Alliance® Certified for Connectivity and Optimizations; integrated flash memory for system software; on-chip memory for state variables; on-chip network stack to offload microcontroller; network features in accordance with TCP, UDP, DHCP, ARP, HTTP, TLS, DNS and SNTP; and flash storage for boot and application.

In some embodiments, the communications gateway may include one or more modules configured for Bluetooth Low Energy (BLE) communications. The BLE module(s) may support at least the following features: connect to the host processor through any suitable means; BLE technology up to the current BLE technology; configuration and software updates; BLE in any suitable class and transmission range; if the module supports integrated WiFi then it may support any suitable frequency band; if integrated with WiFi there may be separate antennas for BLE and Wi-Fi; antennae is external and omni directional; and flash storage for boot and application.

The AV gateway may support a satellite module to allow for remote data and voice. The module may support near real-time, mission-critical communications. The module may include the following features: connection to a host processor or a main processor through any suitable protocol or means; pole-to-pole global coverage; Voice, Circuit Switched Data and any suitable data service; Short Burst Data (SBD) capable; any suitable hardware configuration; any suitable Multiplexing Method; and any suitable frequency Range.

The gateway may include one or more modems configured for cellular communications, such as 4G or Long Term Evolution communications and 5G or New Radio communications. An example 4G modem of a gateway may support: any suitable category cable; Dual-SIM Dual Standby (DSDS); spectrums deployed by global carriers; and connect to host processor through one or more suitable interfaces. The modem may support: integrated C-V2X direct communications, or any other suitable communications.

An example 5G modem may support: NSA (Non Standalone) and SA (Standalone) modes; coverage for suitable global frequency bands; multi-gigabit data rates; multiple antennas and data streams; multi-constellation GNSS capabilities; multiple interfaces; and multiple SIM cards. The modem may support: integrated C-V2X direct communications, high-precision multi frequency global navigation satellite system (HP-GNSS).

In some embodiments, the gateway may support more than one subscriber identity module (SIMs). The SIMs may include eSIMs, programmable SIMs, software-implemented SIMs, or the like. The SIMs may be designed to the current or past industry standard.

In some embodiments, the gateway may be configured with private access point name (APN).

The gateway may support near-field communication (NFC) Reader and Tag technology. The device may support ECMA-340 and ISO/IEC 18092. The NFC reader may communicate with the host processor through any suitable interface. The NFC tag may be passive. The NFC module may have the ability to support Card Emulator mode (for BLE pairing assistance).

The gateway may include a timing module which may provide a master clock for the autonomous domain controllers, vehicle control unit (VCU), and sensors on the vehicle. The source for the timing module may be a pulse per second signal (PPS) from the GNSS module. The timing module may be free running when the source is lost. The gateway may support a suitable protocol stack to distribute the clock to downstream devices.

The gateway may include flash and SSD storage. The gateway may include flash storage (e.g., an eMMC memory) for boot and application images. The capacity of the flash storage may be a predetermined number of GB. All system-on-modules (SOMs) on the device may provide eMMC for boot images.

The gateway may support secure flash storage for storing information such as configuration, state of AV vehicle, Access Management, entitlements, etc. This storage may be encrypted.

The gateway may support a modular SSD storage with multiple trays (like in a server). Each tray may be capable of being removed and swapped. Storage may be communicated with the main processor through any suitable interface. SSD storage may support a filesystem for multimedia data. All writes to the storage may be encrypted. Filesystem used may be any suitable filesystem. Each storage tray may be of any suitable size in Tera bytes.

Storage of the gateway may be partitioned to support various communication and data storage modules on the AV. Each partition may be encrypted and access restricted based on the security policies. The data written to the storage may be mission specific. For each mission the storage partitions may be created.

The AV gateway may support a two-way audio streaming between a microphone/speaker in the truck cabin and a command center, oversight system, control tower, or the like. The gateway may connect to the microphone/speaker through a suitable data communication system and may support any suitable codecs.

The gateway may be capable of live streaming video, raw or encoded, to the cloud. The source for the video may come from the truck cabin and the ADC units through the ethernet interface, and the gateway may support any suitable codecs.

In some embodiments, the gateway may be capable of waking up from an external signal. The gateway may be capable of waking up through a CAN bus message. The gateway may have capability to enable or disable each of the subsystems described herein. The host processor and NFC may always be functional when the gateway is powered.

The gateway may include a GNSS module that supports any of the following features: any suitable international satellite positioning systems; Anti-Jamming, Multi-tone Active Interference Canceler; configurable frequency of pulse; and message integrity protection, geofencing, spoofing detection.

The gateway may support Dedicated Short Range Communication (DSRC) or Cellular-V2X (C-V2X) communication compliant to 802.11P as standalone modules or integrated into other radio (4G/5G) modules.

In some embodiments, the gateway may be configured for hardware health monitoring (HM). HM may provide the following features: monitoring of different rails on the board; power sequencing at start-up; log all critical errors - power failures, number of soft resets, watch dog failures; and control hardware communications and activity to maintain vehicle safety.

IV.(c) Example Gateway Software-Implemented Features

In some embodiments, a communications gateway may be configured with a basic input/output system (BIOS) that is configured to support secure boot and power on self-test (POST). There may also be a command to enable/disable the POST. In some embodiments, the BIOS may include diagnostic software that may support debugging any suitable modules or interfaces associated with an AV, including specific modules and datapaths, as well as to perform both local and remote tests.

In some embodiments, the communications gateway may support a real time operating system (OS). The OS architecture may support implementation of any suitable container modules.

The gateway may support any suitable protocols for a network stack, including authentication protocols. The VCUs or electronic control units (ECUs) on an AV may conform to an automotive open system architecture (AUTOSAR) standard in its most current implementation or in a suitable older implementation.

IV.(d) Example Embedded Security Features

The system-on-modules (SOMs) of the gateway are configured with security features including: an ability to communicate with a trusted platform module (TPM) compliant to suitable standards; an architecture that supports a trusted execution environment; an integrated (embedded) hardware security module (HSM); non-volatile secure storage available to the system application; a secure boot process that has its trust rooted in hardware; and an runtime integrity system that has its trust rooted in hardware.

SOMs may support hardware accelerated cryptographic schemes for any of the following: encryption/decryption; hash; Message Authentication Codes; Digital Signature (generation and verification); key generation; and key encapsulation.

The Wi-Fi module of the gateway may support the following features: hardware accelerated symmetric encryption/decryption; ability to authenticate trusted access points; password protection; symmetric/asymmetric cryptographic acceleration; and rotating password.

The cellular communication module (e.g., for 4G/5G) may support cryptographic acceleration. The LTE/5G modem may provide the ability to close/block open default networking ports. The two eSIMs may have the ability to update their firmware.

The host processor may support DPI (Deep Packet Inspection) engines and support line rate IDS.

Firewall may be supported on all external interfaces of the AV Gateway. Firewall may be supported between the domains for accessing data and communication. All communications between the device and in-vehicle devices may be encrypted.

IV.(e) Example Gateway Capabilities

The gateway may perform in accordance with various capabilities, thresholds, requirements, or the like described herein when performing various communications operations. These may include performance capabilities related to latency, throughput, CAN bus operation, CPU utilization, storage, and privacy/security.

Real time video streaming and real time audio streaming may meet jitter and latency requirements. In particular, the latency for audio streaming may not exceed a predetermined time interval (e.g., 15 milliseconds, 20 milliseconds, 30 milliseconds, 40 milliseconds, 50 milliseconds).

The gateway may transport data at line rate and meet latency/jitter requirements for voice and video traffic. Interfaces may perform without errors at all temperature ranges.

Transmission time on a CAN bus may not exceed a predetermined time interval (e.g., 10 milliseconds, 15 milliseconds, 20 milliseconds, 25 milliseconds).

Utilization of the CPU may not exceed a predetermined threshold amount (e.g., 50%, 60%, 70%, 80%) when encryption/decryption engines are being used. Utilization may not exceed a predetermined threshold amount (e.g., 50%, 60%, 70%, 80%) when all interfaces are functional.

Read and write to the storage when encryption and decryption is in use may not impact the throughput and CPU utilization.

Execution of security features may not impact the above requirements.

The gateway may support multiple domains isolating the functionality and enhancing security. All messaging and data exchange between domains may be enabled through policies.

The gateway may process the incoming messages depending on the message types and priority defined. For example, the following message types may be prioritized in the listed order: 1. MRC (minimal risk condition); 2. Config; 3. Streaming—Audio/Video; 4. Status—Alarms; 5. Updates—MAPS; 6. OTA (over the air); and 7. Diagnostics.

The gateway may support an algorithm to prioritize traffic and bandwidth to meet latency and jitter requirements. In some embodiments, an algorithm prioritizes traffic and bandwidth in the listed order: 1. Voice; 2. Video; and 3. Messages. On the WAN side: bandwidth may be reserved for a pre-determined minimum number of Video channels; and bandwidth may be reserved for a pre-determined minimum number of Audio channels.

In some embodiments, reliability of the gateway device is provided at least in part via the health monitoring (HM) subsystem described herein. At pre-set or pre-determined power thresholds, or dynamically determined power thresholds, the gateway may turn off at least some of its components in a predetermined sequence.

In some embodiments, the gateway is configured to provide and prioritize availability of communications between the AV and a remote oversight system. There may be a connection available for cloud communications, for example. Use of cellular network communication (e.g., 4G/5G) may be prioritized over the use of the satellite modem or other connectivity options.

In promoting availability, the gateway may support dual modem and dual antenna. The availability exhibited by the gateway may extend past communication/connectivity availability; for example, the gateway provides storage availability. The gateway may make the storage available at all times for sensor data storage, OTA, policy updates, or the like.

The host processor, microcontroller and all SOMs on the gateway may support OTA. The gateway may perform as OTA manager and facilitate the OTA updates on all vehicle ECU's (electronic control units, e.g., vehicle controller). All OTA packages may be stored on the device. Features of OTA Manager may include: authentication of packages; aware of all the devices in the vehicle and be capable of querying the information from the devices; dependencies between devices for OTA updates; capable of performing OTA on a specific device or group of devices; and perform critical updates when the vehicle is in motion. Devices that may be supported: ADC; VCU; sensors; and CVC (central vehicle computer). For devices supported by the CVC, the OTA manager may forward the software packages after verifying the authenticity of the packages.

The host processor and each SOM on the gateway may provide any relevant hardware component information such that the gateway may be identified.

The gateway may support an IEEE 1149.1 Standard Test Access Port and Boundary-Scan Architecture connection to the host processor. The gateway may support a serial port connected to the host processor. All SOMs may be accessible through the serial port of the host processor. One of the Ethernet ports may be identified to support local debugging.

The HM module may be the external watchdog. Each of the cores on the host processor may support watchdog through HSM.

The gateway may support an external temperature sensor. The sensor may be monitored by the HM module. For example, the HM module of the gateway may determine, via the external temperature sensor, whether the gateway device is overheating and provide a health alert to the host processor or other SOMs of the gateway.

The gateway may store all logging messages to the SSD storage. The host processor on the device and all SOMs on the device may support logging. The gateway may be capable of enabling logging and its levels remotely. The gateway may be capable of messaging downstream devices to enable/disable logging at different levels. Logging may be configured according to the following example levels: information; warnings; and debugging.

The gateway may be aware of vehicle position, e.g., terminal, on mission. The gateway may exchange periodic messages with all in-vehicle devices to verify connectivity. The gateway may monitor or be aware of the state of the vehicle battery.

The gateway may generate alarms for the following conditions: loss of connectivity to any in-vehicle units; over-the-air failures; component thresholds; transitions of the master clock; storage thresholds; communications thresholds; transitions of the interfaces; and policy updates. In some embodiments, the alarms are transmitted to at least one of the VCU or the oversight system, depending on connectivity availability. In some embodiments, the alarms are indicated (e.g., via a display, via audio) to a human operator in a cabin of the vehicle. In some embodiments, communication of an alarm to the VCU is configured to cause the VCU to perform a minimal risk condition (MRC) maneuver and bring the autonomous vehicle to a complete stop.

IV.(f) Example Antenna Configurations

External antennas may be supported for any of the communication modules on the AV. One or more antennas may be placed on or in an autonomous vehicle is any suitable location.

IV.(g) Example Gateway Electrical Features

The gateway may be connected to the vehicle's power network for purposes of powering the device through a connection hereafter referred to as VBATT. The gateway may be connected to redundant power inputs.

IV.(h) Example Gateway Compliance

The gateway may be compliant to any cellular communications standards which apply to vehicles or autonomous vehicles, and the gateway may include carrier certifications from cellular service providers. Any applicable WiFi or Bluetooth standards which apply to vehicles or autonomous vehicles may be adhered to. The gateway may support ASIL-B or any other functional safety standards which apply to vehicles or autonomous vehicles may be adhered to. The gateway may adhere to various original equipment manufacturer (OEM) hardware environmental requirements for at least operating environments and non-operating environments. Components of the gateway may be automotive grade compliant.

### IV. Example Gateway Implementations

According to various embodiments, the autonomous vehicle may include more than one communications gateway device for redundancy. As the communications enabled by a communications gateway, including cloud communication, local external communication, and in-vehicle communication, are critical to the operation of the autonomous vehicle, the redundancy provided by more than one gateway device enables such operation to continue despite potential failures in a single communications gateway. Thus, a communications gateway device may be accompanied by another communications gateway device configured to provide redundant functionality. The redundant functionality of a second communications gateway device may refer to the second communications gateway device having the same communications functionality and capabilities as a first communications gateway device, such as those described herein, such that the same communication operations can be performed by the second communications gateway device in the event of failure of the first communications gateway device.

In some embodiments, a communications gateway device is configured and used to communicate with the oversight system that is remote from the autonomous vehicle. In some embodiments, the communications gateway device includes a plurality of sub-modules, including a cellular communication sub-module (e.g., configured for LTE/5G), a Wi-Fi and Bluetooth sub-module, a satellite sub-module or a GNSS/GPS sub-module, a security sub-module, and an ethernet sub-module.

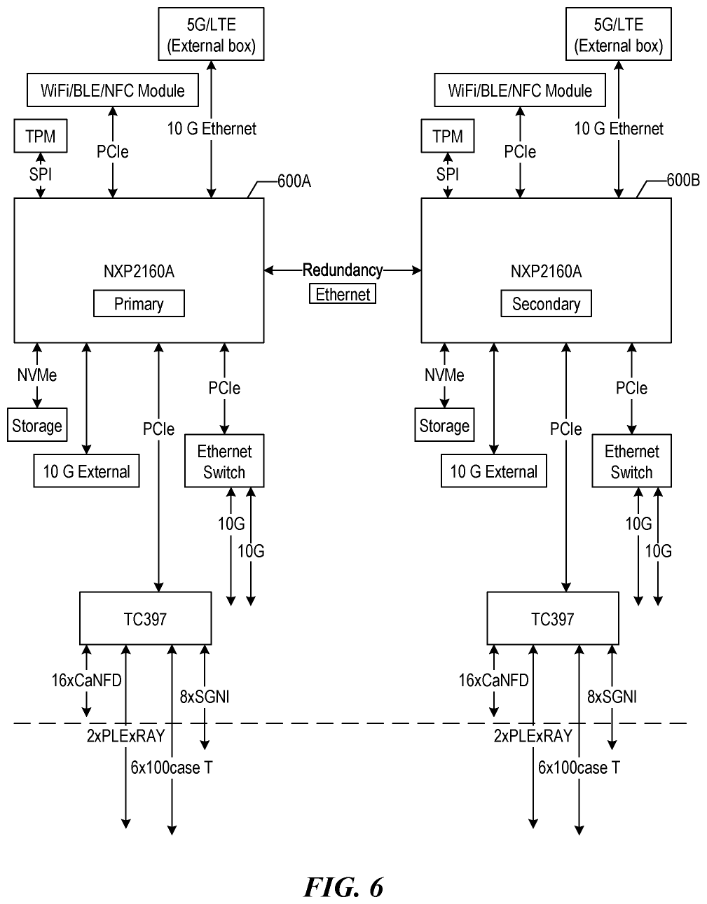

As shown in FIGS. 6-14, a communications gateway device is coupled with various other components located in or on the autonomous vehicle, such as other communications gateway devices, vehicle control units, storage banks or memory devices, autonomous driving systems and/or the like, in various configurations.

In some embodiments, a communications gateway device is coupled to other vehicle components via a switch that provides high speed, low latency, serial communication between the communications gateway device and at least the storage devices and the autonomous driving system. For example, the switch is a peripheral component interconnect express (PCIe) switch. In some embodiments, the communications gateway device is coupled to other vehicle components via an ethernet switch that provides ethernet connection of different speeds (e.g., 1 gigabit, 5 gigabit, 10 gigabit, and/or the like) for connectivity between different subsystems and components in the vehicle.

In some embodiments, the satellite sub-module (e.g., a satellite modem) provides connectivity to the oversight system as a backup to the cellular communication sub-module.

In some embodiments, a communications gateway device communicates with an ADS system that includes a plurality of individual autonomous domain controllers (ADCs). Each ADC performs a specific role, such as perception or sensor data collection, and communicates with other ADCs, the communications gateway device, the VCU, and the oversight system. In some embodiments, each ADC is configured to read and write to a storage bank or memory device.

FIGS. 6-9 provide diagrams of example configurations of two or more gateway devices to provide redundancy and enable continued operation in the event of individual gateway failures. In some embodiments that implement a redundant gateway configuration, a remote computer is configured to identify each gateway device of a vehicle when communicating with the vehicle, and the remote computer transmits messages to each of the gateway devices of the vehicle.

FIG. 6 illustrates a first example gateway configuration that includes two communications gateways 600A and 600B. As illustrated, the two communications gateways 600A and 600B may each be connected to the respective modules, such as respective Wi-Fi/BLE/NFC modules. Further, the two communications gateways may communicate with each other via an Ethernet connection or any other suitable communication interface or modality. For example, via an Ethernet connection between the two communications gateways 600A and 600B, each communication gateway can be aware of a respective gateway priority, or whether each communication gateway is the primary gateway or the secondary gateway. In some embodiments, the two communications gateways may communicate with each other to verify received data, to synchronize transmissions, or the like.

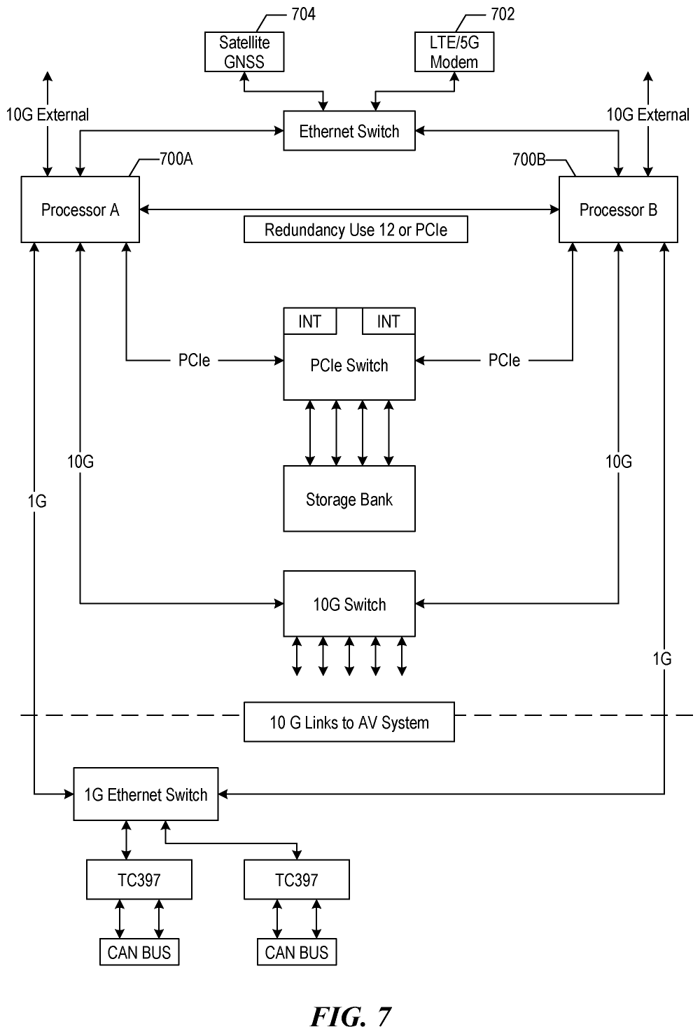

FIG. 7 illustrates another example gateway configuration, in which two processors 700A and 700B are connected to various communications modules via switches. The illustrated embodiment of FIG. 7 provides a redundant gateway where the two processors are across a communications interface, such as peripheral component interface express (PCIe), providing a multi-box solution. In the illustrated embodiments, the two processors 700A and 700B may share communications modules, such as a cellular communication module 702 and a satellite module 704, and may be communicate with shared communication modules via switches. Thus, generally, the example gateway configuration of FIG. 7 provides processor redundancy and storage.

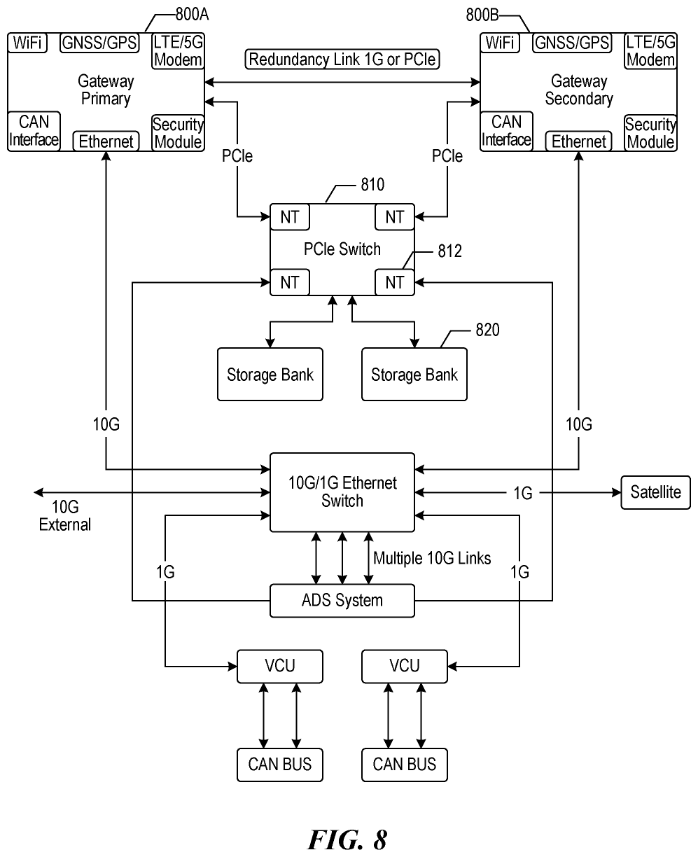

FIG. 8 illustrates another example gateway configuration. As illustrated in FIG. 8, the configuration includes a primary gateway device 800A and a secondary gateway device 800B. The two gateway devices are coupled to a PCIe switch 810 which includes a plurality of non-transparent bridges 812. Each gateway device corresponds to a different non-transparent bridge 812. The VCU and a plurality of ADCs of the ADS are connected to the PCIe switch 810. One or more memory devices are connected to the PCIe switch 810. Accordingly, the two gateway devices communicate data, via the PCIe switch, with the VCU, ADCs, and memory devices.

In some embodiments, the two gateway devices 800A and 800B are each associated with a gateway priority (e.g., primary, secondary), which is communicated between each gateway device via a redundancy link. For example, the gateway devices communicate with each other via an Ethernet connection or PCIe. In some embodiments, the gateway priority controls an order by which the gateway devices store data in the memory devices, communicate with the VCU or ADCs, transmit/receive messages, and/or the like.

In some embodiments, the configuration includes a number of memory devices 820 that corresponds to the number of gateway devices (e.g., two). In some embodiments, each gateway device corresponds to a memory device 820 and reads/stores data with the corresponding memory device 820. In some embodiments, the primary gateway device 800A and the secondary gateway device 800B are configured to read from and write to each memory device 820.

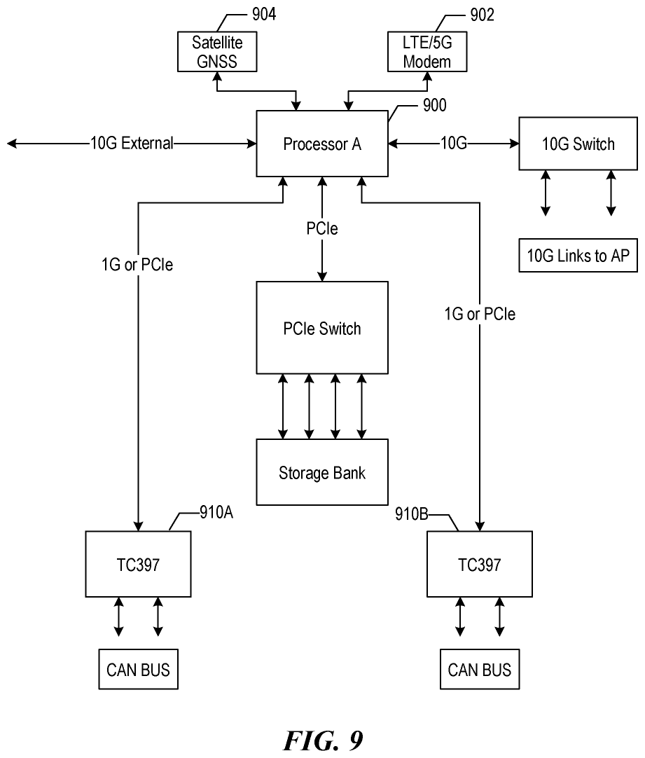

FIG. 9 illustrates another example gateway configuration featuring gateway redundancy with an external satellite/GNSS module and an external cellular communications module (e.g., LTE/5G). For example, a processor 900 is coupled with a cellular communications module 902 and a satellite module 904, and the processor 900 may communicate data received via the cellular communications module 902 or the satellite module 904 redundantly to two controllers 910A and 910B. As illustrated, each controller 910A or 910B is connected to a CAN bus and can provide redundant functionality for each other.

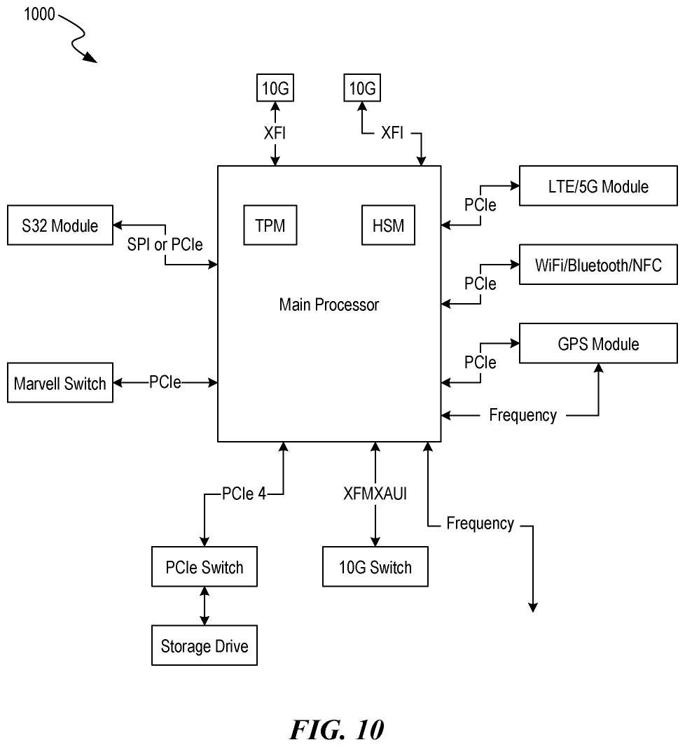

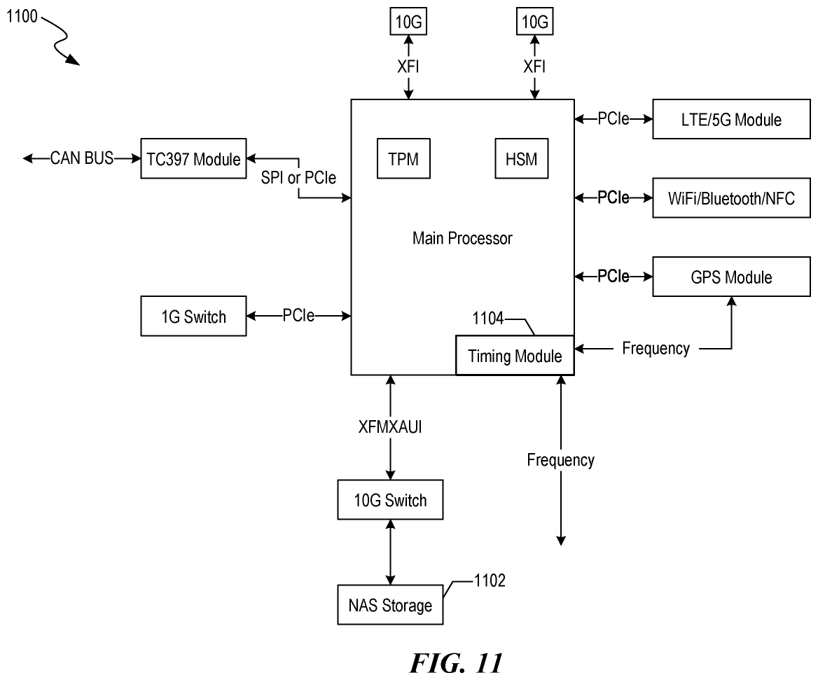

FIGS. 10 and 11 illustrate diagrams of example gateway implementations, including non-redundant implementations of a communications gateway device.

FIG. 10 illustrates another example gateway configuration 1000 feature a non-redundant single box in which Wi-Fi, GNSS, and cellular communication modules are integrated.

FIG. 11 illustrates another non-redundant single box gateway configuration 1100 in which Wi-Fi, GNSS, and cellular communication modules are integrated. The illustrated gateway configuration further includes network attached storage (NAS) 1102. In some embodiments, the NAS 1102 may be shared by the gateway device and other in-vehicle devices.

As illustrated in FIG. 11, the gateway device includes a timing module 1104. In some embodiments, the timing module 1104 is configured to provide timing information to subsystems located in or on the vehicle, such as a sensor subsystem. For example, the timing information includes a system frequency, and by providing the timing information to a sensor subsystem, or a plurality of sensors, the sensor subsystem collects sensor data at the system frequency. Accordingly, the timing module 1104 of the gateway device enables synchronization between different subsystems and operations for autonomous operation of the autonomous vehicle. In some embodiments, the timing information is synchronized based on receiving a satellite signal, such as a pulse-per-second (PPS) signal. In some embodiments, the timing information is received from an oversight system or remote computer.

In some embodiments, the gateway device (or the timing module 1104 of the gateway device) includes a processor that performs operations including receiving a satellite signal (e.g., via a satellite modem or sub-module), providing timing information that is based on the satellite signal to one or more subsystems located in or on the vehicle, and receiving sensor data collected by the subsystems in accordance with the timing information.

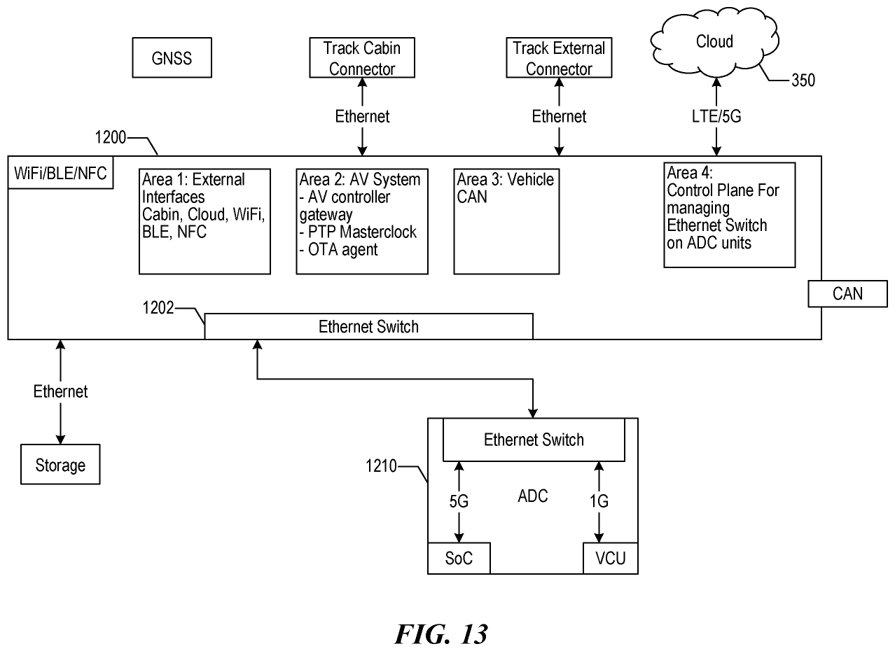

FIGS. 12 and 13 illustrate example implementations in which autonomous domain controllers (ADCs) are coupled with communications gateway devices. In FIGS. 12 and 13, one or more ADCs 1210 are connected to a gateway device 1200. Each ADC 1210 is configured to perform functionality associated with a specific role such as perception or sensor data collection related to autonomous operation of a vehicle. One or more ADCs 1210 form an autonomous driving system. The communications gateway device includes an ethernet switch, and the device implements a control plane for managing the ethernet switch 1202 between the multiple ADCs. In some embodiments, the ADCs communicate data with the gateway device via ethernet communication.

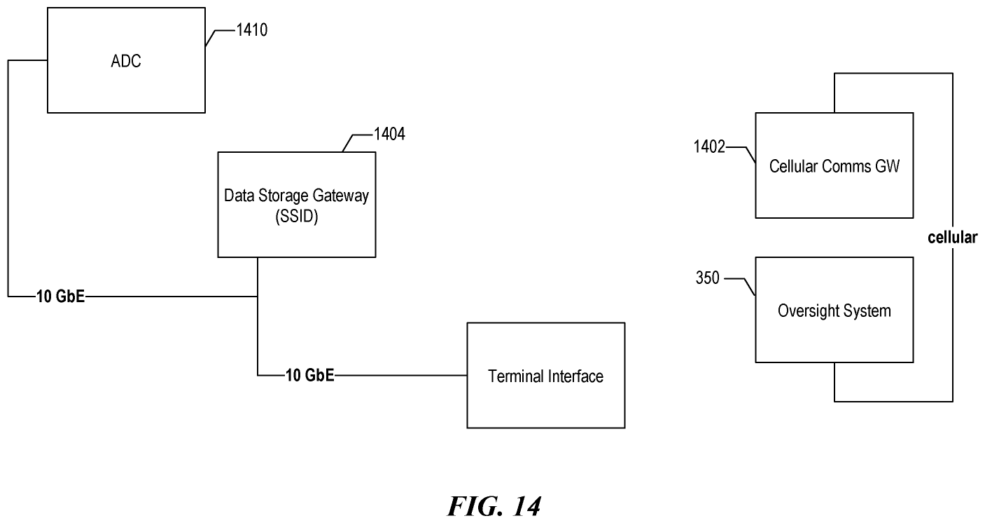

Turning now to FIG. 14, an implementation that includes a plurality of communications gateway devices. As illustrated, the example implementation includes a cellular communication gateway device 1402 configured to use cellular communications (e.g., LTE, 5G, 6G) to communicate with an oversight system 350. In some embodiments, the example implementation further includes a data storage gateway device 1404 configured communicate data between an autonomous domain controller 1410 and a terminal interface. For example, in some embodiments, the ADC 1410 stores data on the data storage gateway device 1404, and the stored data on the data storage gateway device 1404 is accessed by a vehicle control unit, or a computer located on the vehicle.

Accordingly, in some embodiments, an autonomous vehicle may include a plurality of communications gateway devices that each correspond to a different function or purpose for operation of the vehicle. In some embodiments, an autonomous vehicle includes at least one cellular communication gateway device 1402 that corresponds to an oversight communications function, at least one data storage gateway device 1404 that corresponds to an in-vehicle communications function, and at least one vehicle telematics gateway that corresponds to a vehicle health communication function.

In order to perform the above features, an autonomous vehicle may utilize any of the sensors, particularly the data obtained from the sensors, in conjunction with the computing facilities on-board the autonomous vehicle, such as those associated with or in communication with the VCU. Alternatively, or additionally, the above features may be executed by an autonomous vehicle with aid from an oversight system, or control center, and optionally with aid from a human remote-control operator. The oversight system, and in some cases the remote-control operator, may communicate environmental data, map updates, instructions, or other information to an autonomous vehicle. An on-board map, such as a high-definition map, may be used by an autonomous vehicle to accomplish some of the features described herein, particularly when knowledge of location and local regulations (e.g., speed limits, obligations under the law, traffic conventions, intersection types) is needed to complete a task described in the feature.

While this document refers to an autonomous truck, it should be understood that any autonomous ground vehicle may have such features. Autonomous vehicles which traverse over the ground may include: semis, tractor-trailers, 18 wheelers, lorries, class 8 vehicles, passenger vehicles, transport vans, cargo vans, recreational vehicles, golf carts, transport carts, and the like.

Some example technical solutions implemented by preferred embodiments are listed below.

1. A communications gateway device of a vehicle, comprising: a first module configured to wirelessly communicate a first data with a remote computer at a remote location outside of the vehicle; a second module configured to communicate a second data with one or more devices located within a vicinity external to the vehicle; and a processor configured to perform operations comprising: obtaining operational data that describes an operation of the vehicle; providing the operational data to the remote computer via the first module or to the one or more devices via the second module; and receiving, via the first module, instructional data from the remote computer, wherein the instructional data is configured to cause operation of the vehicle.

2. The communications gateway device of solution 1, further comprising a third module configured to communicate a third data with one or more subsystems within the vehicle.

3. The communications gateway device of solution 2, wherein the processor is configured to transmit, via the first module, the third data to the remote computer within a predetermined time of the third data being collected by the subsystems.

4. The communications gateway device of solution 2, wherein the operations further comprise: receiving, via the first module, a satellite signal including a timing signal; providing, via the third module, timing information to the subsystems located within the vehicle, wherein the timing information is based on the timing signal; and receiving, via the third module, sensor data collected by the subsystems in accordance with the timing information.

5. The communications gateway device of solution 2, wherein the third module comprises at least one of one or more Ethernet interfaces or a controller area network (CAN) interface.

6. The communications gateway device of solution 1, wherein the first module comprises at least one of a satellite modem or one or more cellular modems, wherein the second module comprises at least one of a NFC module, a Bluetooth module, or a Wi-Fi module.

7. The communications gateway device of solution 1, wherein the processor is configured to perform operations further comprising: defining a plurality of software security environments each corresponding to one of the first module or the second module.

8. The communications gateway device of solution 1, wherein the one or more devices located within a vicinity external to the vehicle include a physical key device that is configured to allow access into the vehicle, and wherein the second data includes near-field communications (NFC) data exchanged with the physical key device.

9. The communications gateway device of solution 8, wherein the processor is configured to perform operations further comprising:

responsive to receiving the second data that includes NFC data indicating a presence of the physical key device, enabling access to an interior portion of the vehicle.

10. The communications gateway device of solution 2, wherein the processor is configured to perform operations further comprising: determining that a first data is not able to be communicated with the remote computer via the first module; and transmitting an indication to a vehicle control computer to cause the vehicle to reach a complete stop based on the first data being not able to be communicated with the remote computer.

11. An autonomous driving system for a vehicle, comprising: a communications gateway device comprising: a first module configured to wirelessly communicate a first data with a remote computer located at a remote location outside of the vehicle, a second module configured to communicate a second data with one or more devices located in a vicinity external to the vehicle, a third module configured to communicate a third data with one or more subsystems located in or on the vehicle, and a computer located in the vehicle and configured to control autonomous operation of the vehicle based on receiving the first data and the third data.

12. The autonomous driving system of solution 11, wherein the one or more subsystems located in or on the vehicle include an audio sensor configured to collect audio data or a camera configured to collect image data.

13. The autonomous driving system of solution 12, wherein the communications gateway device is configured to transmit, to the remote computer via the first module, the audio data or the image data within a predetermined time of the audio data or the image data being collected by the audio sensor or the camera.

14. The autonomous driving system of solution 11, wherein the communications gateway device comprises a processor configured to perform operations comprising: receiving, via the first module, a satellite signal; providing, via the third module, timing information to the subsystems located in or on the vehicle, wherein the timing information is based on the satellite signal; and receiving, via the third module, sensor data collected by the subsystems in accordance with the timing information.

15. The autonomous driving system of solution 11, wherein the first processor defines a plurality of software security environments each corresponding to one of the first module, the second module, or the third module, and wherein a software security environment is configured for processing of data related to a respective module.

16. The autonomous driving system of solution 11, wherein the one or more devices located within a vicinity external to the vehicle include a physical key device that is configured to allow access to the vehicle, and wherein the second module is configured to detect a presence of the physical key device based on near-field communications (NFC) with the physical key device.

17. The autonomous driving system of solution 11, wherein the computer located in the vehicle is configured to perform operations comprising: receiving, from the communications gateway device, information that indicates an error, interruption, or unavailability of wireless communication with the remote computer via the first module; determining a trajectory for the vehicle to reach a complete stop based on receiving sensor data that was obtained via the third module; and transmitting, via the third module, instructions to the subsystems located in or on the vehicle to cause the vehicle to operate in accordance with the trajectory.

18. The autonomous driving system of solution 11, wherein the computer comprises a plurality of autonomous domain controllers each configured to interface with the communications gateway device via the third module.

19. The autonomous driving system of solution 11, further comprising:

a second communications gateway device configured to be redundant to the communications gateway device.

20. The autonomous driving system of solution 19, wherein a gateway priority of each of the communications gateway device and the second communications gateway device is communicated between the communications gateway device and the second communications gateway device, and wherein the gateway priority controls an order by which the communications gateway device and the second communications gateway device store data in a memory device.

21. The autonomous driving system of solution 19, wherein the second communications gateway device is configured to write data to a respective memory device that is separate from a memory device associated with the communications gateway device.

22. The autonomous driving system of solution 19, wherein the communications gateway device and the second communications gateway device are coupled to one or more memory devices via a switch.

23. A remote computer configured to remotely communicate with a plurality of vehicles, the remote computer comprising a processor configured to perform operations comprising: determining an instructional data for a vehicle of the plurality of vehicles based on data previously received from one or more of the plurality of vehicles; identifying one or more communications gateway devices associated with the vehicle; and transmitting the instructional data to each of the one or more communications gateway devices associated with the vehicle.

24. The remote computer of solution 23, wherein the instructional data is configured to (i) be provided by the one or more communications gateway devices to a control computer located on the vehicle, and (ii) cause an operation of the vehicle.

25. The remote computer of solution 23, wherein the data that is previously received is received from one or more communications gateway devices for each of the one or more vehicles, and wherein the data comprises sensor data collected from a sensor subsystem of each of the one or more vehicles.

26. The remote computer of solution 23, wherein the operations further comprise: in response to the instructional data including a streaming request, receiving audio data or image data from the one or more communications gateway devices associated with the vehicle, wherein the audio data or image data is received within a predetermined amount of time from the audio data or image data being collected at the vehicle.

27. The remote computer of solution 23, wherein the operations further comprise: transmitting, to the one or more communications gateway devices associated with the vehicle, timing information configured to control collection of sensor data at the vehicle.

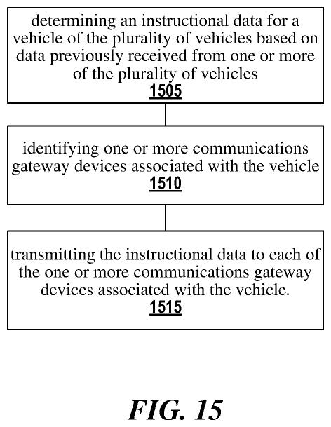

28. A method for remote communication between a plurality of vehicles and a remote computer (e.g., as depicted in FIG. 15), comprising: determining (1505) an instructional data for a vehicle of the plurality of vehicles based on data previously received from one or more of the plurality of vehicles; identifying (1510) one or more communications gateway devices associated with the vehicle; and transmitting (1515) the instructional data to each of the one or more communications gateway devices associated with the vehicle.

29. The method of solution 28, wherein the instructional data is configured to (i) be provided by the one or more communications gateway devices to a control computer located on the vehicle, and (ii) cause an operation of the vehicle.

30. The method of solution 28, wherein the data that is previously received is received from one or more communications gateway devices for each of the one or more vehicles, and wherein the data comprises sensor data collected from a sensor subsystem of each of the one or more vehicles.

31. The method of solution 28, wherein the operations further comprise: in response to the instructional data including a streaming request, receiving audio data or image data from the one or more communications gateway devices associated with the vehicle, wherein the audio data or image data is received within a predetermined amount of time from the audio data or image data being collected at the vehicle.

32. The method of solution 28, wherein the operations further comprise: transmitting, to the one or more communications gateway devices associated with the vehicle, timing information configured to control collection of sensor data at the vehicle.

While several embodiments have been provided in this disclosure, it should be understood that the disclosed systems and methods might be embodied in many other specific forms without departing from the spirit or scope of this disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of this disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and may be made without departing from the spirit and scope disclosed herein.

Implementations of the subject matter and the functional operations described in this patent document can be implemented in various systems, semiconductor devices, ultrasonic devices, digital electronic circuitry, or in computer software, firmware, or hardware, including the structures disclosed in this specification and their structural equivalents, or in combinations of one or more of them. Implementations of aspects of the subject matter described in this specification can be implemented as one or more computer program products, e.g., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming languages, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of nonvolatile memory, media and memory devices, including by way of example semiconductor memory devices, e.g., EPROM, EEPROM, and flash memory devices. The processor and the memory can be supplemented by, or incorporated in, special purpose logic circuitry.

While this patent document contains many specifics, these should not be construed as limitations on the scope of any invention or of what may be claimed, but rather as descriptions of characteristics that may be specific to particular embodiments or sections of particular inventions. Certain characteristics that are described in this patent document in the context of separate embodiments or sections can also be implemented in combination in a single embodiment or a single section. Conversely, various characteristics that are described in the context of a single embodiment or single section can also be implemented in multiple embodiments or multiple sections separately or in any suitable sub combination. A feature or operation described in one embodiment or one section can be combined with another feature or another operation from another embodiment or another section in any reasonable manner. Moreover, although characteristics may be described above as acting in certain combinations and even initially claimed as such, one or more characteristics from a claimed combination can in some cases be excised from the combination, and the claimed combination may be directed to a sub combination or variation of a sub combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described, and other implementations, enhancements and variations can be made based on what is described and illustrated in this patent document.

What is claimed is:

1. A communications gateway device of a vehicle, comprising:
a first module configured to wirelessly communicate a first data with a remote computer at a remote location outside of the vehicle;
a second module configured to communicate a second data with one or more devices located within a vicinity external to the vehicle; and
a processor configured to perform operations comprising:
obtaining operational data that describes an operation of the vehicle;
providing the operational data to the remote computer via the first module or to the one or more devices via the second module; and
receiving, via the first module, instructional data from the remote computer, wherein the instructional data is configured to cause operation of the vehicle.

2. The communications gateway device of claim 1, further comprising a third module configured to communicate a third data with one or more subsystems within the vehicle.

3. The communications gateway device of claim 2, wherein the processor is configured to transmit, via the first module, the third data to the remote computer within a predetermined time of the third data being collected by the subsystems.

4. The communications gateway device of claim 2, wherein the operations further comprise:
receiving, via the first module, a satellite signal including a timing signal;
providing, via the third module, timing information to the subsystems located within the vehicle, wherein the timing information is based on the timing signal; and
receiving, via the third module, sensor data collected by the subsystems in accordance with the timing information.

5. The communications gateway device of claim 2, wherein the third module comprises at least one of one or more Ethernet interfaces or a controller area network (CAN) interface.

6. The communications gateway device of claim 1,
wherein the first module comprises at least one of a satellite modem or one or more cellular modems,
wherein the second module comprises at least one of a NFC module, a Bluetooth module, or a Wi-Fi module.

7. The communications gateway device of claim 1, wherein the processor is configured to perform operations further comprising: defining a plurality of software security environments each corresponding to one of the first module or the second module.

8. The communications gateway device of claim 1, wherein the one or more devices located within a vicinity external to the vehicle include a physical key device that is configured to allow access into the vehicle, and wherein the second data includes near-field communications (NFC) data exchanged with the physical key device.

9. The communications gateway device of claim 8, wherein the processor is configured to perform operations further comprising:
responsive to receiving the second data that includes NFC data indicating a presence of the physical key device, enabling access to an interior portion of the vehicle.

10. The communications gateway device of claim 2, wherein the processor is configured to perform operations further comprising:
determining that a first data is not able to be communicated with the remote computer via the first module; and
transmitting an indication to a vehicle control computer to cause the vehicle to reach a complete stop based on the first data being not able to be communicated with the remote computer.

11. An autonomous driving system for a vehicle, comprising:
a communications gateway device comprising:
a first module configured to wirelessly communicate a first data with a remote computer located at a remote location outside of the vehicle,
a second module configured to communicate a second data with one or more devices located in a vicinity external to the vehicle,
a third module configured to communicate a third data with one or more subsystems located in or on the vehicle, and
a computer located in the vehicle and configured to control autonomous operation of the vehicle based on receiving the first data and the third data.

12. The autonomous driving system of claim 11, wherein the one or more subsystems located in or on the vehicle include an audio sensor configured to collect audio data or a camera configured to collect image data, and wherein the communications gateway device is configured to transmit, to the remote computer via the first module, the audio data or the image data within a predetermined time of the audio data or the image data being collected by the audio sensor or the camera.

13. The autonomous driving system of claim 11, wherein the computer located in the vehicle is configured to perform operations comprising:
receiving, from the communications gateway device, information that indicates an error, interruption, or unavailability of wireless communication with the remote computer via the first module;
determining a trajectory for the vehicle to reach a complete stop based on receiving sensor data that was obtained via the third module; and
transmitting, via the third module, instructions to the subsystems located in or on the vehicle to cause the vehicle to operate in accordance with the trajectory.

14. The autonomous driving system of claim 11, further comprising:
a second communications gateway device configured to be redundant to the communications gateway device.

15. The autonomous driving system of claim 14, wherein a gateway priority of each of the communications gateway device and the second communications gateway device is communicated between the communications gateway device and the second communications gateway device, and wherein the gateway priority controls an order by which the communications gateway device and the second communications gateway device store data in a memory device.

16. The autonomous driving system of claim 14, wherein the second communications gateway device is configured to write data to a respective memory device that is separate from a memory device associated with the communications gateway device.

17. The autonomous driving system of claim 14, wherein the communications gateway device and the second communications gateway device are coupled to one or more memory devices via a switch.

18. A remote computer configured to remotely communicate with a plurality of vehicles, the remote computer comprising a processor configured to perform operations comprising:
determining an instructional data for a vehicle of the plurality of vehicles based on data previously received from one or more of the plurality of vehicles;
identifying one or more communications gateway devices associated with the vehicle; and
transmitting the instructional data to each of the one or more communications gateway devices associated with the vehicle.

19. The remote computer of claim 18, wherein the instructional data is configured to (i) be provided by the one or more communications gateway devices to a control computer located on the vehicle, and (ii) cause an operation of the vehicle.

20. The remote computer of claim 18, wherein the operations further comprise:
in response to the instructional data including a streaming request, receiving audio data or image data from the one or more communications gateway devices associated with the vehicle, wherein the audio data or image data is received within a predetermined amount of time from the audio data or image data being collected at the vehicle.
